(19) United States
(12) Patent Application Publication
(10) Pub. No.: US 2017/0180465 A1
(43) Pub. Date: Jun. 22, 2017

(54) METHOD, INFORMATION PROCESSING APPARATUSES AND NON-TRANSITORY COMPUTER-READABLE STORAGE MEDIUM

(71) Applicant: FUJITSU LIMITED, Kawasaki-shi (JP)

(72) Inventors: Hiroyuki Yamashima, Kawasaki (JP); KAZUHIRO SUZUKI, Kawasaki (JP); Soichi Shigeta, Yokohama (JP)

(73) Assignee: FUJITSU LIMITED, Kawasaki-shi (JP)

(21) Appl. No.: 15/353,803

(22) Filed: Nov. 17, 2016

(30) Foreign Application Priority Data
Dec. 17, 2015 (JP) 2015-246391

(51) Int. Cl. H04L 29/08; H04L 12/911; H04L 12/26

(52) U.S. Cl. CPC H04L 67/1002; H04L 43/16; H04L 47/70

(57) ABSTRACT

A method using a first information processing apparatus and a load balancing apparatus, the first information processing apparatus being configured to operate as a plurality of virtual machines, the method includes transmitting, by the first information processing apparatus, a plurality of packets to the load balancing apparatus, receiving, by the first information processing apparatus, one or more packets included in the plurality of packets distributed by the load balancing apparatus, deciding, by the first information processing apparatus, a first threshold related to a load of the plurality of virtual machines based on a ratio of a number of the one or more packets to a number of the plurality of packets, and deleting, by the first information processing apparatus, one or more virtual machines included in the plurality of virtual machines when the load of the plurality of virtual machines is less than the first threshold.

### CROSS-REFERENCE TO RELATED APPLICATION

This application is based upon and claims the benefit of priority of the prior Japanese Patent Application No. 2015-246391, filed on Dec. 17, 2015, the entire contents of which are incorporated herein by reference.

### FIELD

The embodiments discussed herein are related to a method, an information processing apparatus and a non-transitory computer-readable storage medium.

### BACKGROUND

Service providers that provide services to users (hereinafter also simply referred to as service providers) construct business systems configured by, for example, a plurality of virtual machines in order to provide various services to the users. According to content of services to be provided to the user or the amounts of processes (hereinafter also simply referred to as process amounts) to be inevitably executed by business systems, service providers install the same applications in a plurality of virtual machines to cause the respective virtual machines to execute the same processes.

In a case in which applications operating in the foregoing business systems are updated, for example, the service providers construct business systems in which the updated applications are installed (hereinafter also referred to as business systems after update) in addition to business systems which are operating (hereinafter also referred to as business systems before update). Then, the service providers cause the business systems after update to execute processes (which are processes of providing services to users) executed by the business systems before update at predetermined timings (hereinafter which is referred to as process switchover). Accordingly, the service providers can execute updating of the applications without interrupting the provision of the services to the users.

In a case in which the foregoing updating of the applications is executed, the service providers execute the process switchover between the business systems before update and the business systems after update step by step in some cases (hereinafter this updating method is also referred to as canary release). By executing the process switchover through the canary release, the service providers can execute generation of virtual machines (hereinafter also referred to as scale-out) in the business systems after update and deletion of virtual machines (hereinafter also referred to as scale-in) in the business system before update step by step according to progress of the process switchover. Therefore, in this case, the service providers can suppress the number of virtual machines inevitably simultaneously disposed in the business systems before update and the business systems after update. Accordingly, the service providers can reduce cost caused with update of applications. Japanese Laid-open Patent Publication No. 2015-115059 and Japanese Laid-open Patent Publication No. 2013-092867 are examples of the related art.

### SUMMARY

According to an aspect of the invention, a method using a first information processing apparatus included in a plurality of information processing apparatuses and a load balancing apparatus coupled to the plurality of information processing apparatuses, the first information processing apparatus being configured to operate as a plurality of virtual machines, the method includes transmitting, by the first information processing apparatus, a plurality of packets to the load balancing apparatus, receiving, by the load balancing apparatus, the plurality of packets, distributing, by the load balancing apparatus, the plurality of packets to the plurality of the information processing apparatus, receiving, by the first information processing apparatus, one or more packets included in the plurality of packets distributed by the load balancing apparatus, deciding, by the first information processing apparatus, a first threshold related to a load of the plurality of virtual machines based on a ratio of a number of the one or more packets to a number of the plurality of packets, and deleting, by the first information processing apparatus, one or more virtual machines included in the plurality of virtual machines when the load of the plurality of virtual machines is less than the first threshold.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of an information processing system 10;

FIG. 2 is a diagram illustrating the detailed configuration of the information processing system 10;

FIG. 3 is a diagram illustrating an application updating method;

FIG. 4 is a diagram illustrating the application updating method;

FIG. 5 is a diagram illustrating another application updating method;

FIG. 6 is a diagram illustrating still another application updating method;

FIG. 7 is a diagram illustrating hardware configurations of physical machines 2A and 2B;

FIG. 8 is a functional block diagram illustrating the physical machine 2A;

FIG. 9 is a block diagram illustrating information stored in an information storage region 230A;

FIG. 10 is a flowchart illustrating a schematic auto-scale process in a first embodiment;

FIG. 11 is a diagram illustrating the schematic auto-scale process in the first embodiment;

FIG. 12 is a flowchart illustrating a detailed schematic auto-scale process in the first embodiment;

FIG. 13 is a flowchart illustrating the detailed schematic auto-scale process in the first embodiment;

FIG. 14 is a flowchart illustrating the detailed schematic auto-scale process in the first embodiment;

FIG. 15 is a flowchart illustrating the detailed schematic auto-scale process in the first embodiment;

FIG. 16 is a flowchart illustrating the detailed schematic auto-scale process in the first embodiment;

FIG. 17 is a flowchart illustrating the detailed schematic auto-scale process in the first embodiment;

FIG. 18 is a diagram illustrating a specific example of current count information 321A;

FIG. 19 is a diagram illustrating a specific example of count management information 322A;

FIG. 20 is a diagram illustrating a specific example of the count management information 322A;

FIG. 21 is a diagram illustrating a specific example of state management information 342A;

FIG. 22 is a diagram illustrating a specific example of the state management information 342A;

FIG. 23 is a diagram illustrating a specific example of disposition number management information 341A;

FIG. 24 is a diagram illustrating a specific example of test packet management information 345A;

FIG. 25 is a diagram illustrating a specific example of measurement ratio management information 344A;

FIG. 26 is a diagram illustrating a specific example of the measurement ratio management information 344A;

FIG. 27 is a diagram illustrating a specific example of administration sequence management information 343A;

FIG. 28 is a diagram illustrating a specific example of the administration sequence management information 343A;

FIG. 29 is a diagram illustrating a specific example of the administration sequence management information 343A;

FIG. 30 is a flowchart illustrating an auto-scale process in a second embodiment;

FIG. 31 is a flowchart illustrating the auto-scale process in the second embodiment;

FIG. 32 is a flowchart illustrating the auto-scale process in the second embodiment;

FIG. 33 is a flowchart illustrating the auto-scale process in the second embodiment; and

FIG. 34 is a diagram illustrating a specific example of system state management information 346A.

### DESCRIPTION OF EMBODIMENTS

In a case in which updating of an application is executed by canary release, abnormality is found in a business system after update (an application after update) during switchover of processes executed by a business system before update to a business system after update in some cases. In the cases, a service provider has to return the processes already switched from the business system before update to the business system after update to the business system before update.

However, in the canary release of the business system having an auto-scale function, virtual machines in the business system before update are deleted in some cases in association with switchover of the processes from the business system before update to the business system after update. Therefore, in a case in which the processes already switched to the business system after update are returned to the business system before update, a process amount to be executed by the business system before update exceeds a processing capability of virtual machines (some of the virtual machines deleted in association with the switchover of the processes) in the business system before update in some cases. Therefore, in the cases, there is a possibility of an influence of delay or the like having on services to be provided to users.

[Configuration of Information Processing System]

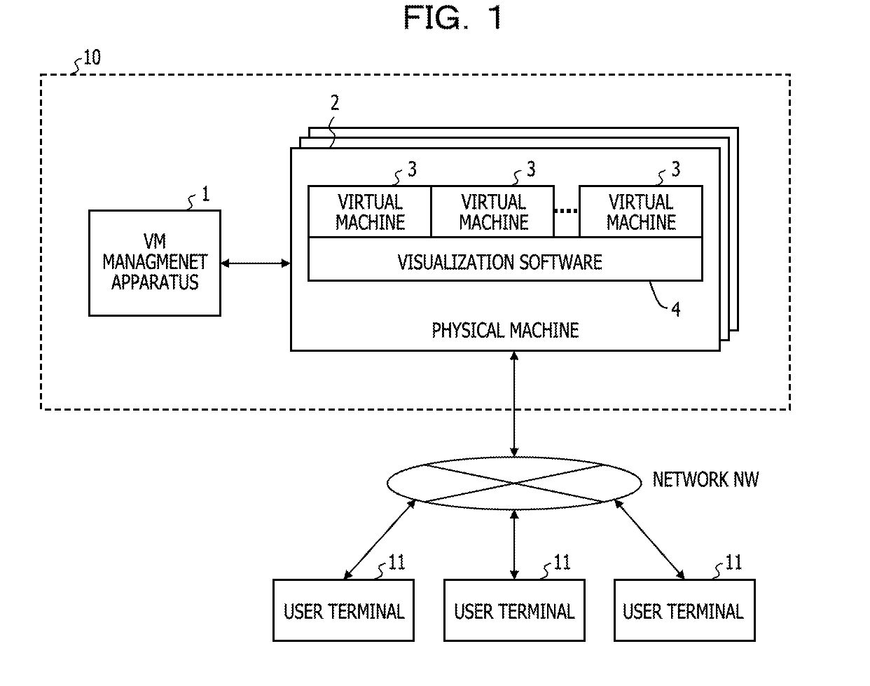

FIG. 1 is a diagram illustrating the configuration of an information processing system 10. The information processing system 10 (hereinafter also referred to as a business system 10) illustrated in FIG. 1 includes a VM management apparatus 1 and a physical machine 2 that generates virtual machines (VMs) 3. Further, user terminals 11 are configured to be able to access the physical machine 2 via a network NW such as the Internet or an intranet.

The physical machine 2 is configured to include a plurality of physical machines in the example of FIG. 1. Each physical machine includes resources such as a central processing unit (CPU), a random access memory (RAM), a hard disk drive (HDD).

The resources of the physical machine 2 can be allocated to the plurality of virtual machines 3. Then, the virtual machines 3 execute processes of providing services to users by a service provider.

The VM management apparatus 1 is, for example, a different physical machine from the physical machine 2. For example, the VM management apparatus 1 can access the physical machine 2 and can execute instructions to generate the virtual machines 3 in the physical machine 2 and managements of the generated virtual machines 3.

The virtualization software 4 is a basis software that operates the virtual machines 3 by allocating the resources of the physical machine 2 according to an instruction from the VM management apparatus 1. The virtualization software 4 operates as, for example, the physical machine 2, as illustrated in FIG. 1.

The user terminal 11 is a terminal that is used for the user to receive a service. For example, the user gives a request for a process to receive a service to the virtual machine 3 through the user terminal 11. Then, for example, the user acquires an execution result of the requested process from the virtual machine 3 through the user terminal 11.

[Details of Configuration of Information Processing System]

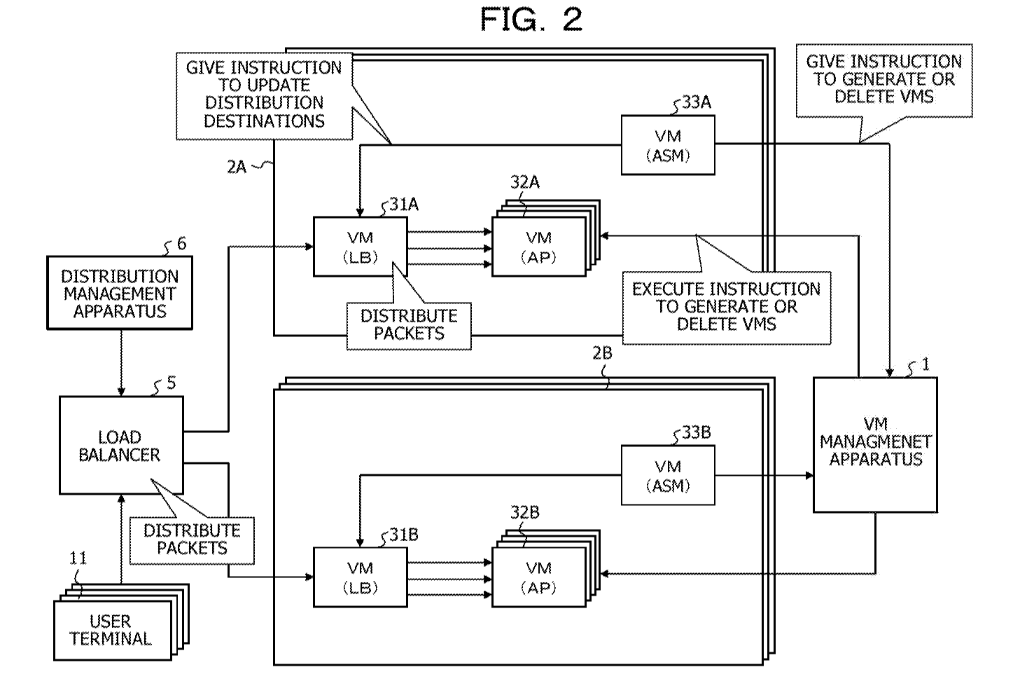

Next, the details of the configuration of the information processing system 10 will be described. FIG. 2 is a diagram illustrating the detailed configuration of the information processing system 10.

In the example illustrated in FIG. 2, the information processing system 10 includes a VM management apparatus 1, physical machines 2A, physical machines 2B, a load balancer 5 (hereinafter also referred to as a load balancing apparatus 5), and a distribution management apparatus 6. In the example illustrated in FIG. 2, the physical machines 2A and 2B are each a plurality of physical machines. The load balancer 5 and the distribution management apparatus 6 may be, for example, different physical machines from the physical machines 2A and 2B or may be virtual machines generated by different physical machines from the physical machines 2A and 2B.

In the example illustrated in FIG. 2, one virtual machine 31A (hereinafter also referred to as an LB-VM 31A or VM (LB) 31A) and a plurality of virtual machines 32A (hereinafter also referred to as AP-VMs 32A, VMs (AP) 32A, or first virtual machines 32A) are generated in the physical machine 2A. In the example illustrated in FIG. 2, one virtual machine 33A (hereinafter also referred to as an ASM-VM 33A or a VM (ASM) 33A) is generated in the physical machine 2A.

The LB-VM 31A is a virtual machine functioning as a load balancer that distributes the packets distributed by the load balancer 5 to the AP-VMs 32A. The AP-VM 32A is a virtual machine in which an application is operated to execute a process of providing a service to a user.

The ASM-VM 33A is, for example, a virtual machine functioning as an auto-scale management apparatus that instructs the VM management apparatus 1 to generate new AP-VMs 32A or delete the existing AP-VMs 32A in the physical machine 2A according to an operation state of each AP-VM 32A. The ASM-VM 33A instructs the LB-VM 31A to change packet distribution destinations in the case in which the ASM-VM 33A generates new AP-VMs 32A or deletes the existing AP-VMs 32A in the physical machine 2A.

In the example illustrated in FIG. 2, one virtual machine 31B (hereinafter also referred to as an LB-VM 31B or VM (LB) 31B) and a plurality of virtual machines 32B (hereinafter also referred to as AP-VMs 32B or VMs (AP) 32B) are generated in the physical machine 2B. In the example illustrated in FIG. 2, one virtual machine 33B (hereinafter also referred to as an ASM-VM 33B or a VM (ASM) 33B) is generated in the physical machine 2B. The LB-VM 31B, the AP-VM 32B, and the ASM-VM 33B are the virtual machines that have the same functions of the LB-VM 31A, the AP-VM 32A, and the ASM-VM 33A, respectively.

That is, the information processing system 10 illustrated in FIG. 2 has two systems of virtual machine groups that include virtual machines executing processes corresponding to packets when the packets transmitted from the user terminals 11 are received. Hereinafter, the virtual machine group including the virtual machines generated in the physical machine 2A is also referred to as a first group and the virtual machine group including the virtual machines generated in the physical machine 2B is also referred to as a second group.

In the example illustrated in FIG. 2, the load balancer 5 distributes the packets received from the user terminals 11 to the LB-VM31A and the LB-VM 31B. A ratio of the packets distributed to the LB-VM31A and the LB-VM 31B may be decided by the distribution management apparatus 6 or may be set in the load balancer 5.

Further, in the example illustrated in FIG. 2, the VM management apparatus 1 generates new virtual machines or the existing virtual machines in a case in which an instruction to generate the new virtual machines or delete the existing virtual machines is received from the ASM-VM 33A or the ASM-VM 33B.

[Application Updating Method (1)]

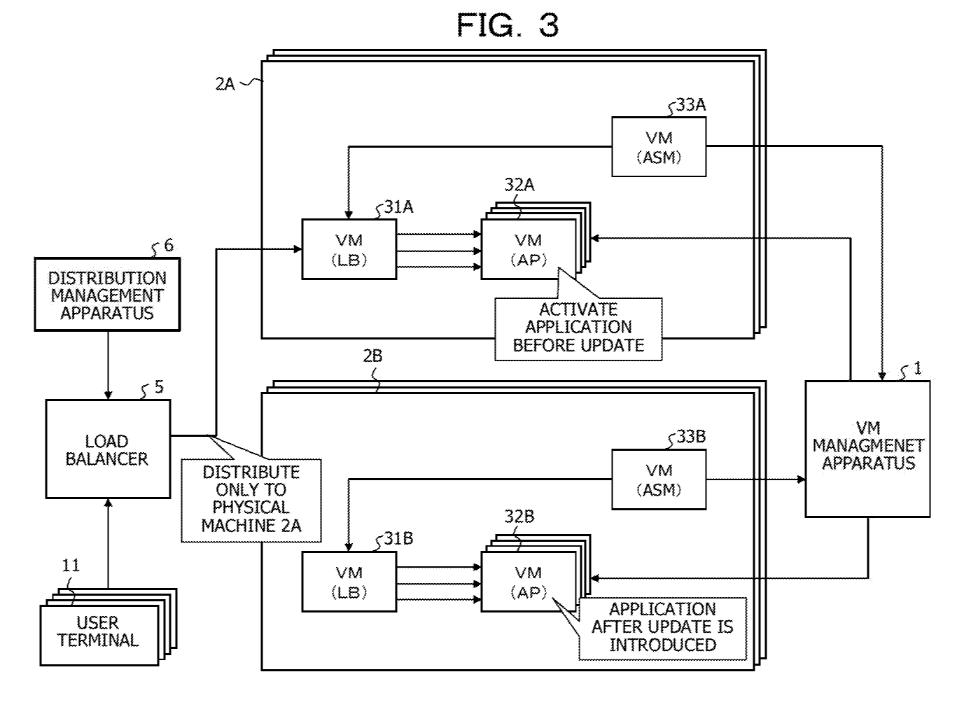

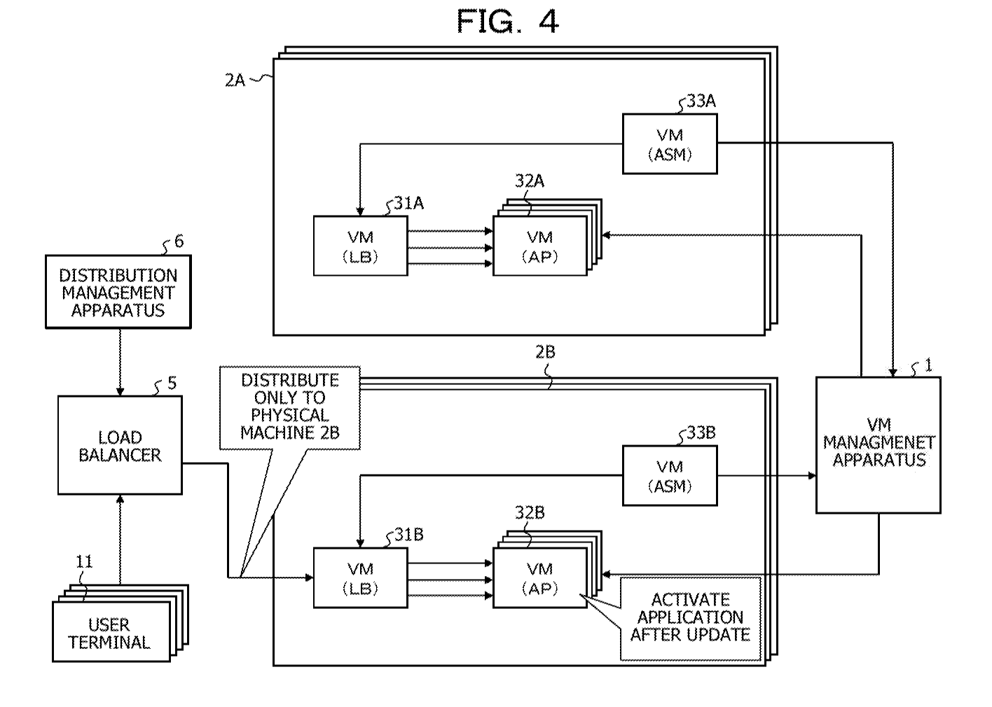

Next, an application updating method executed by the virtual machines will be described. FIGS. 3 and 4 are diagrams illustrating the application updating method.

The AP-VM 32A illustrated in FIG. 3 provides services to the users by executing an application before update. The load balancer 5 illustrated in FIG. 3 distributes the packets only to the LB-VM 31A. That is, the information processing system 10 illustrated in FIG. 3 is in a state in which processes of providing services to the users are executed only by the AP-VMs 32A.

For example, the service provider installs an application after update in the AP-VMs 32B, as illustrated in FIG. 3.

Thereafter, as illustrated in FIG. 4, the distribution management apparatus 6 changes the packet distribution destination by the load balancer 5 from the LB-VM 31A to the LB-VM 31B to execute setting such that the packets are distributed only to the LB-VM 31B. Accordingly, the AP-VM 32B can start executing a process by the application after update according to start of the distribution of the packets via the LB-VM 31B. That is, in this case, the service provider can update the application without interrupting the provision of the services to the users.

[Application Updating Method (2)]

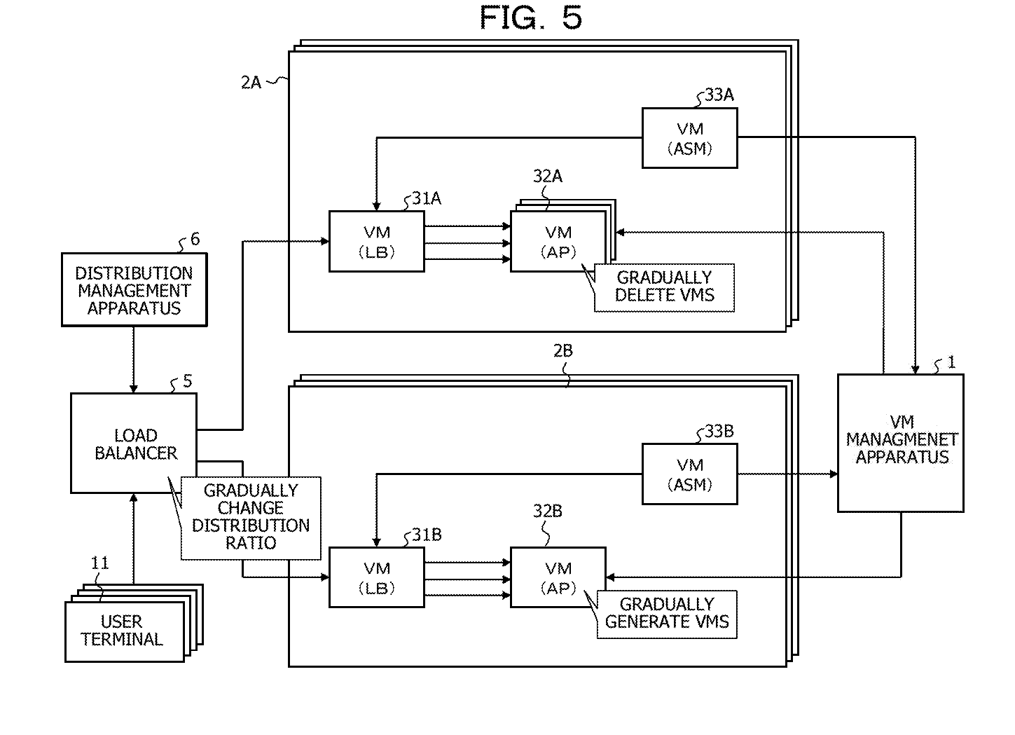

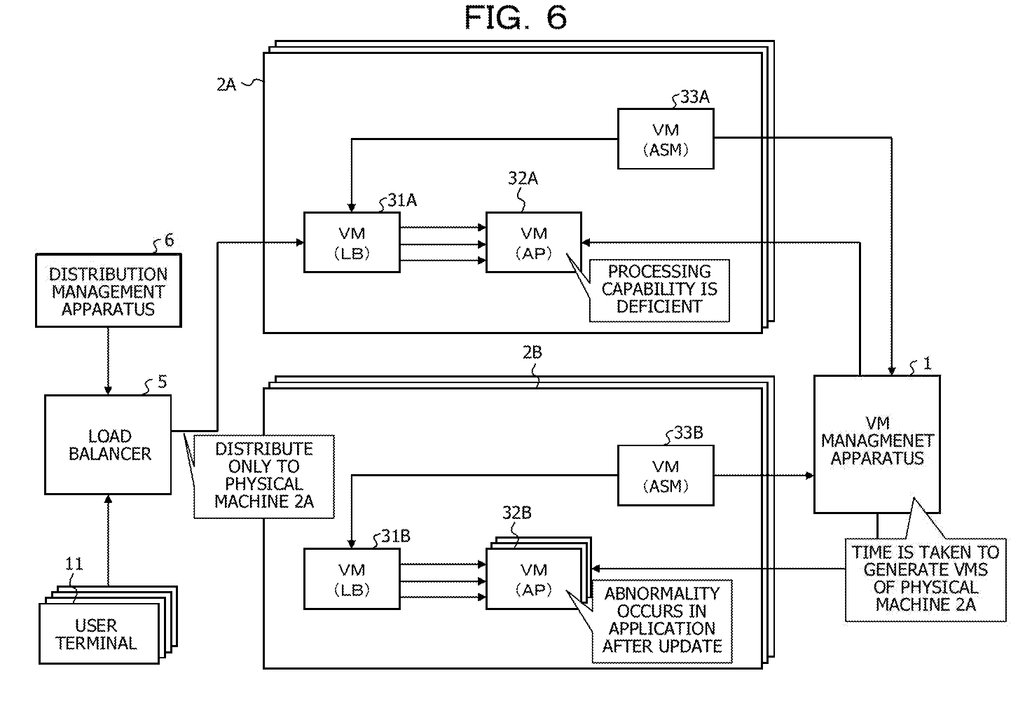

Next, another application updating method executed by the virtual machines will be described. FIGS. 5 and 6 are diagrams illustrating the other application updating method.

The load balancer 5 illustrated in FIG. 5 switches the packet distribution destinations gradually step by step from the LB-VM 31A to the LB-VM 31B by gradually changing a ratio at which the packets are distributed to the LB-VM 31A and the LB-VMs 32B. That is, in the updating method illustrated in FIG. 5, the service provider updates the application through canary release.

In this case, the ASM-VM 33A instructs the VM management apparatus 1 to delete the AP-VMs 32A according to a decrease in a packet amount distributed from the load balancer 5 to the LB-VM 31A (the AP-VMs 32A). On the other hand, the ASM-VM 33B instructs the VM management apparatus 1 to generate the AP-VMs 32B according to an increase in a packet amount distributed from the load balancer 5 to the LB-VM 31B (the AP-VMs 32B).

That is, in the application updating method illustrated in FIG. 5, the number of virtual machines disposed in the physical machines 2A and 2B at the time of updating of the application can be suppressed further than the application updating method described in FIG. 4. Accordingly, the service provider can reduce cost associated with the updating of the application.

Here, in a case in which the application is updated through the canary release, as described above, abnormality is found in the application after update during the switchover of the processes executed by the AP-VMs 32A to the AP-VMs 32B in some cases. In this case, the service provider has to return the processes already switched from the AP-VMs 32A to the AP-VMs 32B to the AP-VMs 32A.

In the canary release, however, the AP-VMs 32A are deleted by the auto-scale function in association with the switchover of the processes from the AP-VMs 32A to the AP-VMs 32B. Therefore, in a case in which the processes already switched to the AP-VMs 32B are returned to the AP-VMs 32A, the AP-VMs 32A (some of the AP-VMs 32A deleted in association with the switchover of the processes), processes exceeding the processing capability have to be executed in some cases in some cases, as illustrated in FIG. 6. As illustrated in FIG. 6, in the VM management apparatus 1, it takes some time to generate new AP-VMs 32A. Accordingly, in this case, there is a possibility of an influence of delay or the like on services to be provided to the users due to the abnormality found in the application after update.

Thus, in the present embodiment, the ASM-VM 33A transmits a predetermined number of test packets to the load balancer 5. Then, the LB-VM 31A acquires the number of test packets distributed from the load balancer 5 among the predetermined number of test packets. Thereafter, the ASM-VM 33A updates threshold information (hereinafter also referred to as first threshold information) used to determine whether to delete the AP-VMs 32A based on the number of acquired test packets and deletes the AP-VMs 32A based on the first threshold and an operation state of the AP-VMs 32A.

That is, the ASM-VM 33A distributes the test packets to the load balancer 5 by transmitting the test packets to the load balancer 5. Thereafter, the ASM-VM 33A measures the number of test packets transmitted to the LB-VM 31A among the test packets distributed by the load balancer 5 to acquire a ratio of the processes switched to other virtual machines (for example, the AP-VMs 32B) among the processes executed by the AP-VMs 32A. Then, the ASM-VM 33A determines whether the AP-VMs 32A are deleted based on the first threshold information to which the ratio of the processes switched to the other virtual machines is reflected.

Accordingly, the ASM-VM 33A can suppress the AP-VMs 32A from being deleted, for example, even in a case in which the processing load of the AP-VMs 32A decreases in association with the switchover of some of the processes executed by the AP-VMs 32A to the other virtual machines. Therefore, even in a case in which a fault of the application after update is found after the switchover of some of the processes from the AP-VMs 32A to the other virtual machines, the AP-VMs 32A can execute the processes to be executed. Thus, the service provider can suppress the services provided to the users from being influenced.

[Hardware Configuration of Information Processing System 10]

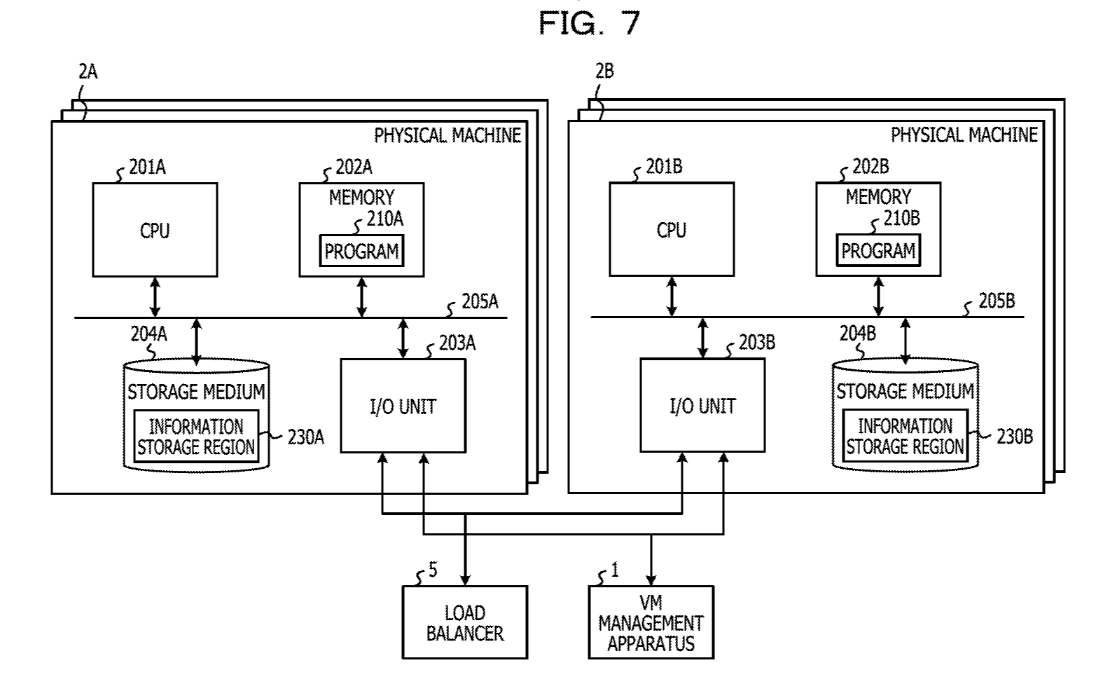

Next, a hardware configuration of the information processing system 10 will be described. FIG. 7 is a diagram illustrating hardware configurations of the physical machines 2A and 2B.

The physical machine 2A includes a CPU 201A which is a processor, a memory 202A, an external interface (I/O unit) 203A, and a storage medium 204A. These units are connected to each other via a bus 205A.

The storage medium 204A stores a program 210A that executes a process of generating new virtual machines 3 or deleting the already generated virtual machines 3 (hereinafter also referred to as an auto-scale process) in the physical machine 2A in a program storage region (not illustrated) in the storage medium 204A. The storage medium 204A has, for example, an information storage region 230A (hereinafter also referred to as a storage unit 230A) in which information used at the time of execution of the auto-scale process is stored.

As illustrated in FIG. 7, the CPU 201A loads the program 210A from the storage medium 204A to the memory 202A and executes the auto-scale process in cooperation with the program 210A at the time of execution of the program 210A. The external interface 203A communicates with the VM management apparatus 1 or the load balancer 5.

The physical machine 2B includes a CPU 201B which is a processor, a memory 202B, an external interface (I/O unit) 203B, and a storage medium 204B. These units are connected to each other via a bus 205B.

For example, the storage medium 204B stores a program 210B that executes an auto-scale process in a program storage region (not illustrated) in the storage medium 204B. The storage medium 204B has, for example, an information storage region 230B (hereinafter also referred to as a storage unit 230B) in which information used at the time of execution of the auto-scale process is stored.

As illustrated in FIG. 7, the CPU 201B loads the program 210B from the storage medium 204B to the memory 202B and executes the auto-scale process in cooperation with the program 210B at the time of execution of the program 210B. The external interface 203B communicates with the VM management apparatus 1 or the load balancer 5.

[Function of Information Processing System]

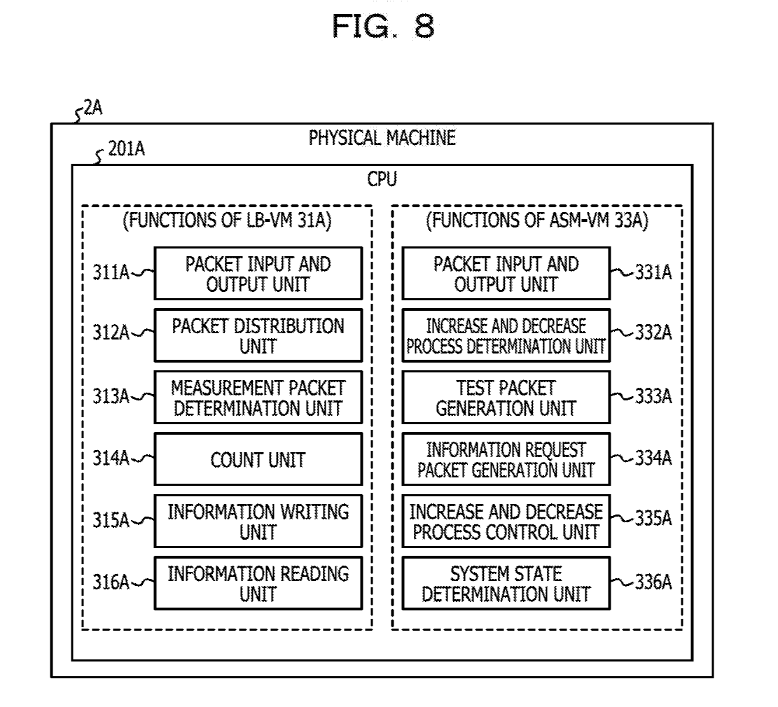

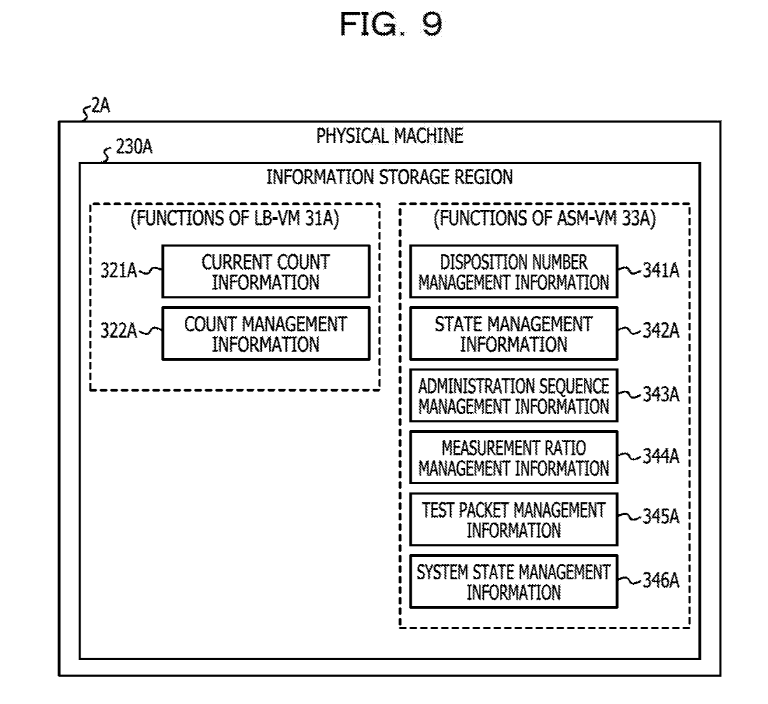

Next, a function of the information processing system 10 will be described. FIG. 8 is a functional block diagram illustrating the physical machine 2A. FIG. 9 is a block diagram illustrating information stored in an information storage region 230A.

As illustrated in FIG. 8, the CPU 201A of the physical machine 2A cooperates with the program 210A to operate as, for example, a packet input and output unit 311A, a packet distribution unit 312A, and a measurement packet determination unit 313A as functions of the LB-VM 31A. As illustrated in FIG. 8, the CPU 201A of the physical machine 2A cooperates with the program 210A to operate as, for example, a count unit 314A, an information writing unit 315A, and an information reading unit 316A as functions of the LB-VM 31A.

As illustrated in FIG. 8, the CPU 201A of the physical machine 2A cooperates with the program 210A to operate as, for example, a packet input and output unit 331A, an increase and decrease process determination unit 332A, and a test packet generation unit 333A as functions of the ASM-VM 33A. As illustrated in FIG. 8, the CPU 201A of the physical machine 2A cooperates with the program 210A to operate as, for example, an information request packet generation unit 334A, an increase and decrease process control unit 335A, and a system state determination unit 336A as functions of the ASM-VM 33A.

In the information storage region 230A, as illustrated in FIG. 9, for example, current count information 321A and count management information 322A are stored as information which is referred to by the LB-VM 31A.

In the information storage region 230A, as illustrated in FIG. 9, for example, disposition number management information 341A, state management information 342A, and administration sequence management information 343A are stored as information which is referred to by the ASM-VM 33A. In the information storage region 230A, as illustrated in FIG. 9, for example, measurement ratio management information 344A, test packet management information 345A, and system state management information 346A are stored as information which is referred to by the ASM-VM 33A.

First, the functions of the LB-VM 31A will be described. The packet input and output unit 311A transmits and receives the packets to and from the load balancer 5 or the AP-VMs 32A.

The packet distribution unit 312A distributes the packets (the packet received by the packet input and output unit 311A) distributed by the load balancer 5 to the AP-VMs 32A. Then, the packet distribution unit 312A instructs the packet input and output unit 311A to transmit the distributed packets. For example, the packet distribution unit 312A may equally distribute the packets distributed by the load balancer 5 to the AP-VMs 32A.

The measurement packet determination unit 313A determines whether the packets transmitted from the load balancer 5 are measurement packets. The measurement packets are packets for measuring process allocation of the AP-VM 32A. Specifically, the measurement packets include test packets which are transmitted to the load balancer 5 by the ASM-VM 33A to measure the process allocation of the AP-VMs 32A. The measurement packets include information request packets which are transmitted to the LB-VM 31A by the ASM-VM 33A to acquire information for measuring the process allocation of the AP-VMs 32A.

The count unit 314A counts up a value indicated by the current count information 321A in a case in which the packets transmitted from the load balancer 5 are the test packets. A specific example of the current count information 321A will be described below.

The information writing unit 315A writes the value indicated by the current count information 321A and a current time in the count management information 322A in a case in which the information request packets are received from the ASM-VM 33A.

The information reading unit 316A reads the number of packets corresponding to the latest time from the count management information 322A and generates reply packets to the information request packets in the case in which the information request packets are received from the ASM-VM 33A. Then, the information reading unit 316A instructs the packet input and output unit 311A to transmit the reply packet.

Next, the functions of the ASM-VM 33A will be described. The packet input and output unit 331A transmits and receives the packets to and from the load balancer 5 or the LB-VM 31A.

The increase and decrease process determination unit 332A determines whether new AP-VMs 32A are generated or the existing AP-VMs 32A are deleted based on the disposition number management information 341A, the state management information 342A, and the administration sequence management information 343A.

The test packet generation unit 333A generates the test packets, for example, in a case in which the increase and decrease process determination unit 332A determines that the AP-VMs 32A are deleted. Then, the test packet generation unit 333A instructs the packet input and output unit 331A to transmit the test packets.

After the test packets are transmitted to the load balancer 5, the information request packet generation unit 334A generates the information request packets after a predetermined time (for example, 10 seconds) has passed. Then, the information request packet generation unit 334A instructs the packet input and output unit 331A to transmit the information request packets.

In a case in which the increase and decrease process determination unit 332A determines that new AP-VMs 32A are generated, the increase and decrease process control unit 335A instructs the packet input and output unit 311A to transmit a packet indicating generation of the new AP-VMs 32A (hereinafter also referred to as a VM generation instruction packet).

In a case in which the increase and decrease process determination unit 332A determines that the existing AP-VMs 32A are deleted, the increase and decrease process control unit 335A executes a measurement ratio confirmation process of determining whether the existing AP-VMs 32A are deleted based on a transmission result of the test packets and the information request packets. The measurement ratio confirmation process will be described below. In a case in which the existing AP-VMs 32A are determined to be deleted in the measurement ratio confirmation process, the increase and decrease process control unit 335A instructs the packet input and output unit 331A to transmit a packet for giving an instruction to delete the existing AP-VMs 32A (hereinafter referred to as a VM deletion instruction packet).

The system state determination unit 336A determines whether the switchover of the processes are currently being executed and the AP-VMs 32A are virtual machines of process switch destinations of the other virtual machines.

The measurement ratio management information 344A, the test packet management information 345A, and the system state management information 346A will be described below.

Hereinafter, the administration sequence management information 343A is assumed to include first threshold information TS1 for determining whether the existing AP-VMs 32A are deleted and second threshold information TS2 for determining whether the new AP-VM 32A are generated in the description.

Hereinafter, the CPU 201B of the physical machine 2B is assumed to operate with the CPU 201A of the physical machine 2A by cooperating with the program 210B in the description. Further, the same information as the information stored in the information storage region 230A is assumed to be stored in the information storage region 230B in the description.

### First Embodiment

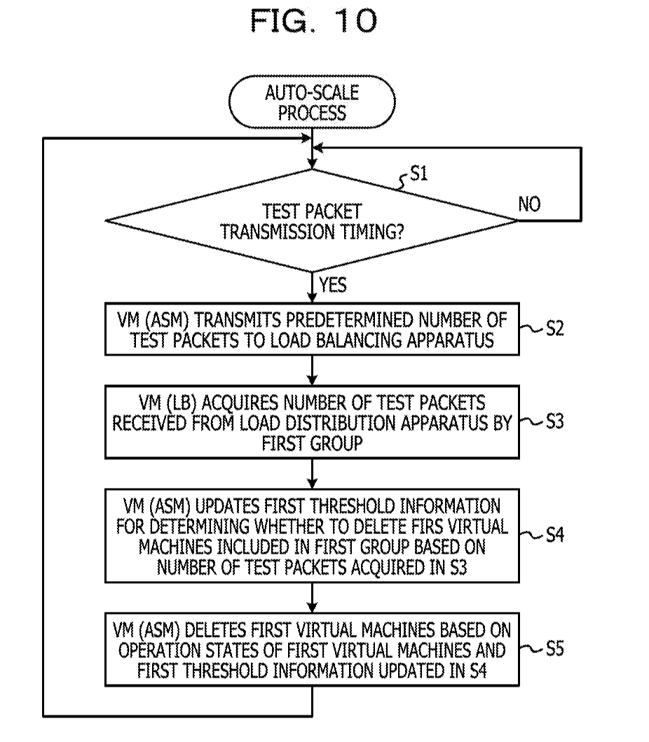

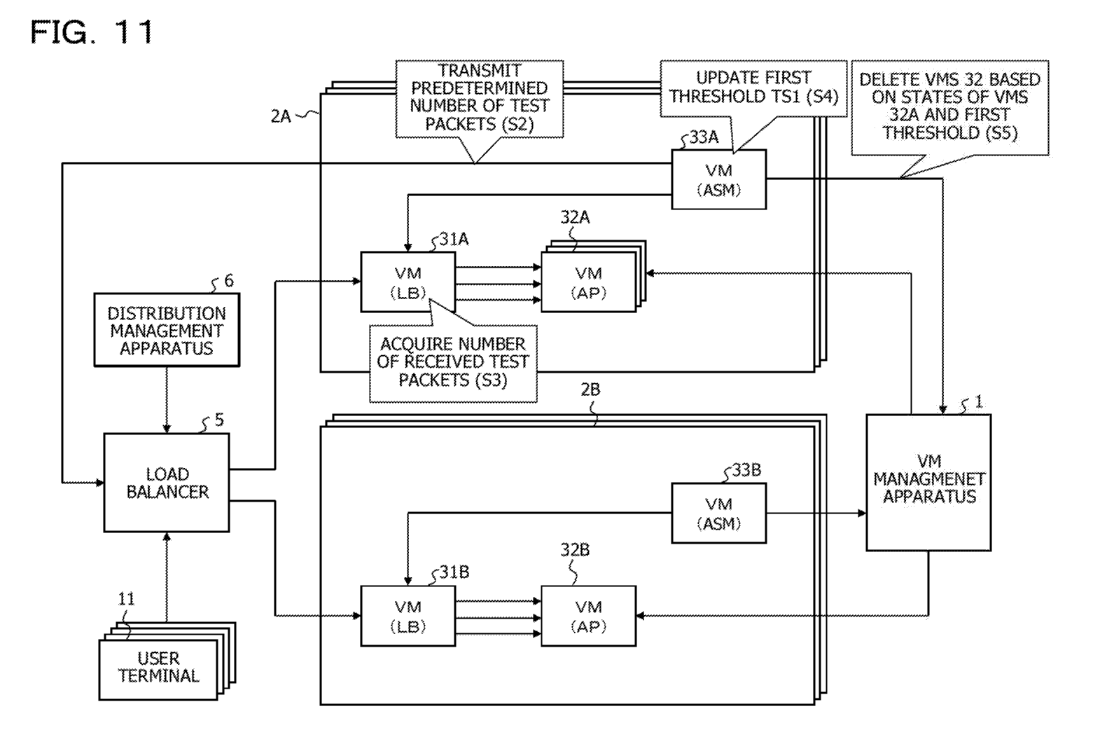

Next, a first embodiment will be described. FIG. 10 is a flowchart illustrating a schematic auto-scale process in a first embodiment. FIG. 11 is a diagram illustrating the schematic auto-scale process in the first embodiment. The schematic auto-scale process in FIG. 10 will be described with reference to FIG. 11.

Referring to the flowchart illustrated in FIG. 10, the auto-scale process in the case in which the already generated AP-VMs 32A in the physical machine 2A are deleted will be described. Only differences from FIG. 2 and the like will be described in FIG. 11.

The ASM-VM 33A first waits until a timing at which the test packets are transmitted (hereinafter also referred to as test packet transmission timing) (NO of S1). The test packet transmission timing may be, for example, a timing at which it is determined whether to execute deletion of the existing AP-VMs 32A.

In a case in which the test packet transmission timing comes (YES of S1), as illustrated in FIG. 11, the ASM-VM 33A transmits a predetermined number of test packets to the load balancer 5 (S2). That is, the ASM-VM 33A transmits the predetermined number of test packets to a plurality of groups (for example, a plurality of groups including the first and second groups) to the load balancer 5.

Thereafter, as illustrated in FIG. 11, the LB-VM 31A acquires the number of test packets received from the load balancer 5 by the first group (S3). Then, the ASM-VM 33A updates the first threshold information TS1 for determining whether to delete the AP-VMs 32A based on the number of test packets acquired in the process of S3 (S4). Further, the ASM-VM 33A deletes the AP-VMs 32A based on operation states of the AP-VMs 32A and the first threshold information TS1 updated in the process of S4 (S5).

That is, in a case in which only the AP-VMs 32A included in the first group execute the processes of providing the services to the users, the predetermined number of test packets transmitted by the load balancer 5 are all transmitted to the first group. Therefore, in a case in which the first group may not receive all of the predetermined number of test packets, the ASM-VM 33A can determine that some of the processes of providing the services to the users are switched to another group (for example, the second group).

Accordingly, even in a case in which information regarding a ratio at which the load balancer 5 distributes the packets to the groups is not acquirable, for example, a case in which another service provider manages the load balancer 5, the service provider can acquire a ratio at which the load balancer 5 distributes the packets to the own group.

Even in a case in which the processing load of the AP-VMs 32A is reduced, the ASM-VM 33A updates the first threshold information TS1 so that the number of AP-VMs 32A to be deleted is suppressed in a case in which the reduction in the processing load is associated with the switchover of the processes.

Accordingly, the AP-VMs 32A can execute processes to be executed even in a case in which abnormality of the application after update is found after the switchover of some of the processes from the AP-VMs 32A to other virtual machines (for example, the AP-VMs 32B). Therefore, the service provider can suppress an influence on the services to be provided to the users.

[Details of First Embodiment]

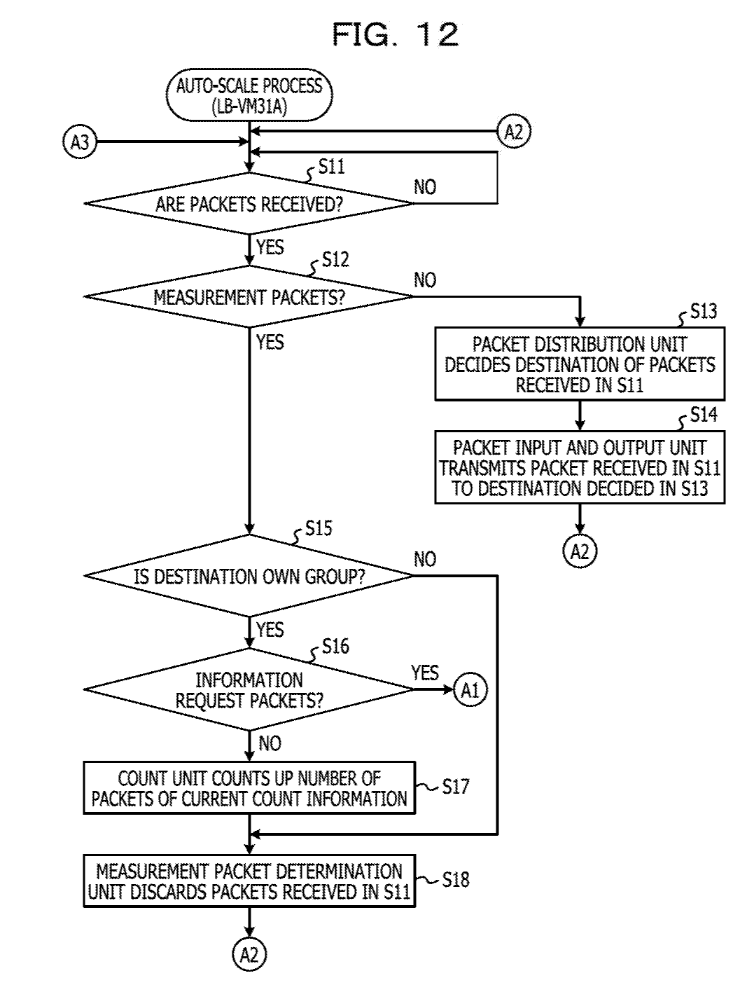

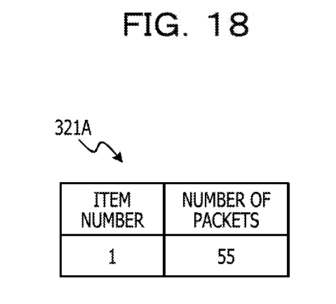

Next, the details of a first embodiment will be described. FIGS. 12 to 17 are flowcharts illustrating the details of the auto-scale process according to the first embodiment. FIGS. 18 to 29 are diagrams illustrating the details of the auto-scale process according to the first embodiment. The details of the auto-scale process in FIGS. 12 to 17 will be described with reference to FIGS. 18 to 29. Hereinafter, the auto-scale process executed in the physical machine 2A will be described.

[Process in LB-VM 31A]

First, the auto-scale process in the LB-VM 31A will be described. The packet input and output unit 311A of the LB-VM 31A waits until the packets distributed by the load balancer 5 are received (NO of S11). Then, in a case in which the packets are received (YES of S11), the measurement packet determination unit 313A of the LB-VM 31A determines whether the packets received by the packet input and output unit 311A are the measurement packets (S12).

As a result, in a case in which the received packets are not the measurement packets (NO of S12), the packet distribution unit 312A of the LB-VM 31A decides a destination of the packets received in the process of S11 (S13).

That is, in a case in which the packets received by the packet input and output unit 311A are not the measurement packets, the received packets are the packets transmitted via the user terminals 11 so that the users can be provided with the services (hereinafter also referred to as process request packets). Therefore, in this case, the packet distribution unit 312A decides one virtual machine among the AP-VMs 32A as the destination of the received process request packets.

Specifically, in this case, the packet distribution unit 312A may decide the virtual machine in which processing resources (an operation ratio of the CPU and a use amount of the memory) are available among the AP-VMs 32A as the destination of the process request packets. Accordingly, the packet distribution unit 312A can cause each AP-VM 32A to execute a process amount suitable for each processing capability.

Then, the packet input and output unit 311A transmits the packets (the process request packets) received in the process of S11 to the AP-VM 32A decided in the process of S13 (S14). Thereafter, the packet input and output unit 311A waits until the subsequent packets are received from the load balancer 5 (NO of S11).

Conversely, in a case in which the packets received in the process of S11 are the measurement packets (YES of S12), the measurement packet determination unit 313A of the LB-VM 31A determines whether the destination of the received measurement packets are the own group (S15). As a result, in a case in which the destination of the received measurement packets is the own group (YES of S15), it is determined whether the received measurement packets are the information request packets (S16).

In a case in which the received measurement packets are not the information request packets, that is, a case in which the received measurement packets are the test packets (NO of S16), the count unit 314A counts up the number of packets of the current count information 321A (S17). The current count information 321A is information indicating the number of test packets received by the packet input and output unit 311A. Hereinafter, a specific example of the current count information 321A will be described.

[Specific Example of Current Count Information]

FIG. 18 is a diagram illustrating a specific example of current count information 321A. The current count information 321A illustrated in FIG. 18 has, as items, an “item number” for identifying each piece of information included in the current count information 321A and “number of packets” in which the number of test packets received by the packet input and output unit 311A is set.

Specifically, in the current count information 321A illustrated in FIG. 18, “55” is set in “number of packets” of information in which “item number” is “1”. Then, in the current count information 321A illustrated in FIG. 18, for example, “56” is set in “number of packets” of the information in which “item number” is “1” in a case in which the packet input and output unit 311A receives a new test packet.

Referring back to FIG. 12, in a case in which the destination of the measurement packets received after the process of S17 or in the process of S11 is not the own group (NO of S15), the measurement packet determination unit 313A discards the measurement packets received in S11 (S18). That is, in a case in which the destination of the measurement packets received in the process of S11 is a group other than the own group (NO of S15), the LB-VM 31A may not inevitably execute a process based on the received measurement packets. In a case in which the measurement packets received in S11 are the test packets destined for the first group and a case in which the process of S17 is executed, the received test packets may not inevitably be stored. Therefore, in this case, the measurement packet determination unit 313A discards the measurement packets received in S11 (S18). Thereafter, the packet input and output unit 311A waits until subsequent packets are received from the load balancer 5 (NO of S11).

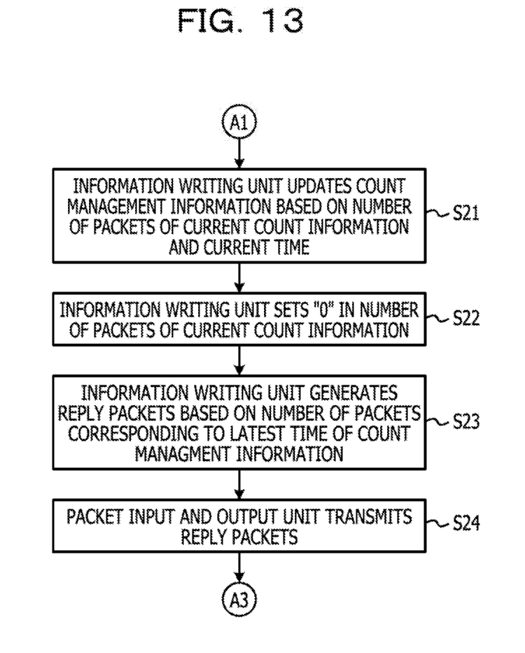

In a case in which the measurement packets received in the process of S11 are the information request packets (YES of S16), the information writing unit 315A of the LB-VM 31A updates the count management information 322A based on the number of packets of the current count information 321A and a current time, as illustrated in FIG. 13 (S21). The count management information 322A is information indicating the number of packets set in the current count information 321A when the packet input and output unit 311A receives the information request packets. Thereafter, the information writing unit 315A sets “0” in the number of packets of the current count information 321A (S22). Hereinafter, a specific example of the count management information 322A will be described.

[Specific Example of Count Management Information]

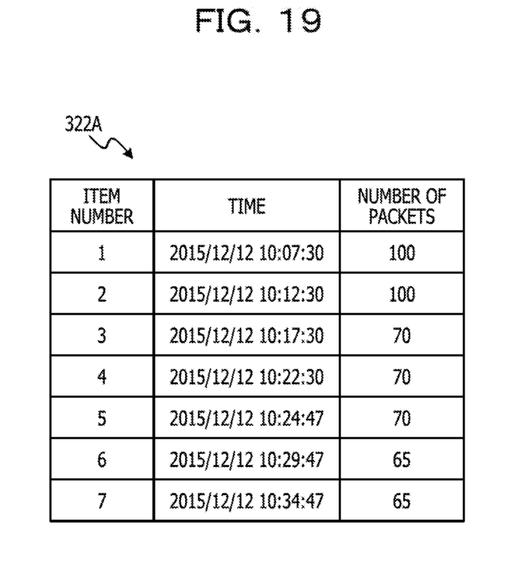

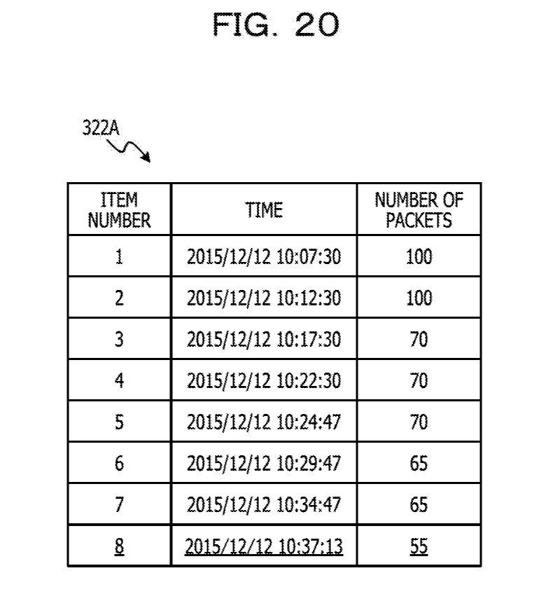

FIGS. 19 and 20 are diagrams illustrating a specific example of count management information 322A. The count management information 322A illustrated in FIGS. 19 and 20 has, as items, an “item number” for identifying each piece of information included in the count management information 322A and a “time” representing a time at which information is set in the count management information 322A. The count management information 322A illustrated in FIG. 19 has, as an item, “number of packets” representing the number of packets set in the current count information 321A when the packet input and output unit 311A receives the information request packets.

Specifically, in the count management information 322A illustrated in FIG. 19, “10:07:30 12/12/2015” is set as “time” and “100” is set as “number of packets” in information of which “item number” is “1”. Further, “10:12:30 12/12/2015” is set as “time” and “100” is set as “number of packets” in information of which “item number” is “2”. Furthermore, “10:17:30 12/12/2015” is set as “time” and “70” is set as “number of packets” in information of which “item number” is “3”. The description of other pieces of information in FIG. 19 will be omitted.

That is, the information of which “item number” is “2” in the count management information 322A illustrated in FIG. 19 indicates that the LB-VM 31A receives 100 test packets from 10:07:30 to 10:12:30 on Dec. 12, 2015. Therefore, in a case in which the number of test packets transmitted by the load balancer 5 is 100 from 10:07:30 to 10:12:30 on Dec. 12, 2015 is 100, the ASM-VM 33A can determine that all of the test packets transmitted by the load balancer 5 are transmitted to the first group. Accordingly, in this case, the ASM-VM 33A can determine that the processes executed by the AP-VMs 32A are not switched to the virtual machines (for example, the AP-VMs 32B) of another group.

On the other hand, the information of which “item number” is “3” in the count management information 322A illustrated in FIG. 19 indicates that the LB-VM 31A receives 70 test packets from 10:12:30 to 10:17:30 on Dec. 12, 2015. Therefore, in a case in which the number of test packets transmitted by the load balancer 5 is 70 from 10:12:30 to 10:17:30 on Dec. 12, 2015 is 100, the ASM-VM 33A can determine that all of the test packets transmitted by the load balancer 5 are not transmitted to the first group. Accordingly, in this case, the ASM-VM 33A can determine that some of the processes executed by the AP-VMs 32A are switched to the virtual machines (for example, the APOVMs 32B) of another group.

In addition, “55” is set in “number of packets” of the information of which “item number” is “1” in the current count information 321A illustrated in FIG. 18. Therefore, as indicated by a underlined portion of FIG. 20, the information writing unit 315A sets “10:37:13 12/12/2015” which is a current time in “time” as information of which “item number” is “8”. As indicated by an underlined portion of FIG. 20, the information writing unit 315A sets “55” set in “number of packets” of the information of which “item number” is “1” in the current count information 321A illustrated in FIG. 18 in “number of packets” as the information of which “item number” is “8”.

Referring back to FIG. 13, after the process of S22, the information writing unit 315A generates reply packets based on the number of packets corresponding to a latest time of the count management information 322A (S23).

Specifically, the latest time in the count management information 322A illustrated in FIG. 20 is “10:37:13 12/12/2015” set in “time” of the information of which “item number” is “8”. Therefore, the information writing unit 315A generates the reply packets so that the information indicating “55” set in “number of packets” of the information of which “item number” is “8” in the count management information 322A illustrated in FIG. 20 is included.

Then, the packet input and output unit 311A transmits the reply packets generated by the information writing unit 315A in the process of S23 to the ASM-VM 33A (S24). Thereafter, the packet input and output unit 311A waits until subsequent packets are received from the load balancer 5 (NO of S11).

[Process in ASM-VM 33A]

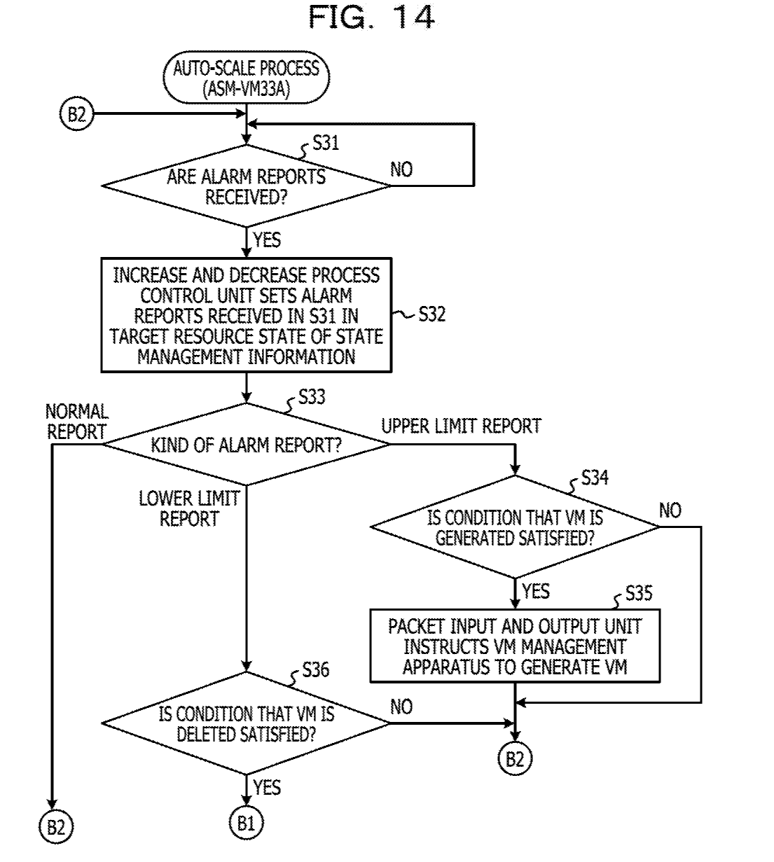

Next, the auto-scale process in the ASM-VM 33A will be described. The packet input and output unit 331A of the ASM-VM 33A waits until alarm reports are received from the AP-VMs 32A, as illustrated in FIG. 14 (NO of S31). The alarm report is a report which is transmitted to the ASM-VM 33A by each AP-VM 32A in a case in which a value indicating an operation state of each AP-VM 32A is greater than a pre-decided standard. Specifically, in a case in which the value indicating the operation state (for example, an operation ratio of the CPU or a use ratio of the memory) is equal to or less than the first threshold TS1, each AP-VM 32A transmits the alarm report (hereinafter, the alarm report of this case is also referred to as an alarm lower limit report or a lower limit report) to the ASM-VM 33A. In a case in which the value indicating the operation state is equal to or greater than the second threshold TS2, each AP-VM 32A transmits an alarm report (hereinafter, the alarm report of this case is also referred to as an alarm upper limit report or an upper limit report) to the ASM-VM 33A. Further, in a case in which the operation state transitions from the state equal to or less than the first threshold TS1 to the state greater than the first threshold TS1 or a case in which the operation state transitions from the state equal to or greater than the second threshold TS2 to the state less than the second threshold TS2, each AP-VM 32A transmits the alarm report (hereinafter, the alarm report of this case is also referred to as a normal alarm report or a normal report) to the ASM-VM 33A. A specific example of the alarm report will be described below.

In a case in which the packet input and output unit 331A receives the alarm reports from the AP-VMs 32A (YES of S31), the increase and decrease process control unit 335A of the ASM-VM 33A sets the alarm report received in the process of S31 to a target resource state of the state management information 342A (S32). The state management information 342A is information for setting the operation state of each AP-VM 32A. Hereinafter, a specific example of the state management information 342A will be described. Hereinafter, five virtual machines (an AP-VM 32A (1), an AP-VM 32A (2), an AP-VM 32A (3), an AP-VM 32A (4), and an AP-VM 32A (5)) are assumed to exist as the AP-VM 32A in the description.

[Specific Example of State Management Information]

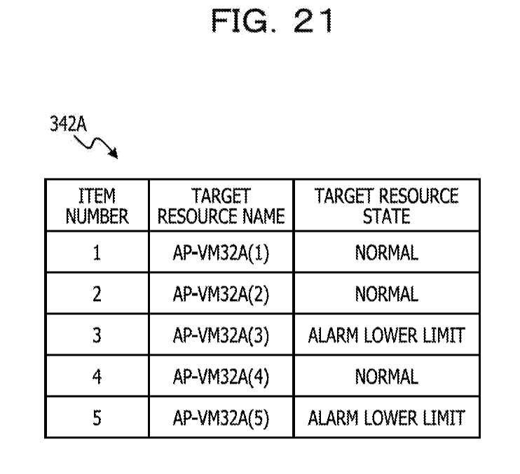

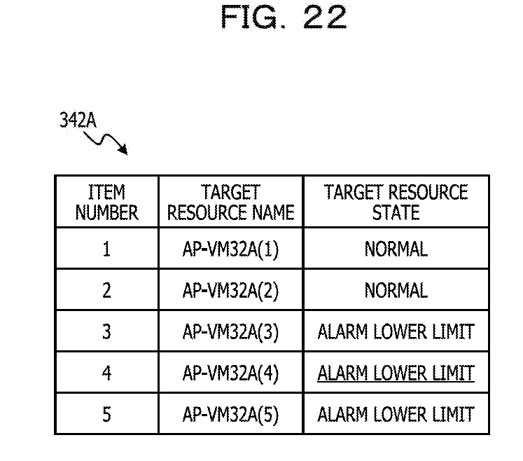

FIGS. 21 and 22 are diagrams illustrating a specific example of state management information 342A. The state management information 342A illustrated in FIGS. 21 and 22 has, as items, “item number” for identifying each piece of information included in the state management information 342A, “target resource name” for identifying each AP-VM 32A, and “target resource state” representing the state of each AP-VM 32A. In “target resource state”, “alarm lower limit” representing that the value indicating the operation state of the AP-VM 32A is equal to or less than the first threshold TS1 and “alarm upper limit” representing that the value indicating the operation state of the AP-VM 32A is equal to or greater than the second threshold TS2 are set. In “target resource state”, “normal” representing that the value indicating the operation state of the AP-VM 32A is neither equal to or less than the first threshold TS1 nor equal to or greater than the second threshold TS2 is set.

Specifically, in the information of which “item number” is “1” in the state management information 342A illustrated in FIG. 21, “AP-VM 32A (1)” is set in “target resource name” and “normal” is set in “target resource state”.

For example, in a case in which the packet input and output unit 331A receives the alarm lower limit report transmitted from the AP-VM 32A (4) (YES of S31), the increase and decrease process control unit 335A sets “alarm lower limit” in “target resource state” of the information of which “target resource name” is “AP-VM 32A (4)”, as indicated by an underlined portion of FIG. 22.

Referring back to FIG. 14, the increase and decrease process determination unit 332A determines a kind of alarm report received by the packet input and output unit 331A in the process of S31 (S33). In a case in which the received alarm report is the alarm upper limit report (the upper limit report of S33), the increase and decrease process determination unit 332A determines whether each AP-VM 32A satisfies a condition that a new virtual machine is generated (S34). Specifically, in this case, the increase and decrease process determination unit 332A refers to the state management information 342A. In a case in which “alarm upper limit” is set in all “target resource states”, the increase and decrease process determination unit 332A determines whether each AP-VM 32A satisfies the condition that a virtual machine is generated.

In the process of S34, the increase and decrease process determination unit 332A may refer to the disposition number management information 341A indicating the number of virtual machines which can be disposed in the physical machine 2A. In a case in which new virtual machines are generated in the physical machine 2A but a disposition number is not equal to or greater than the maximum disposition number of the virtual machines which can be disposed in the physical machine 2A, it may be determined that each AP-VM 32A satisfies the condition that the virtual machine is generated. Hereinafter, a specific example of the disposition number management information 341A will be described.

[Specific Example of Disposition Number Management Information]

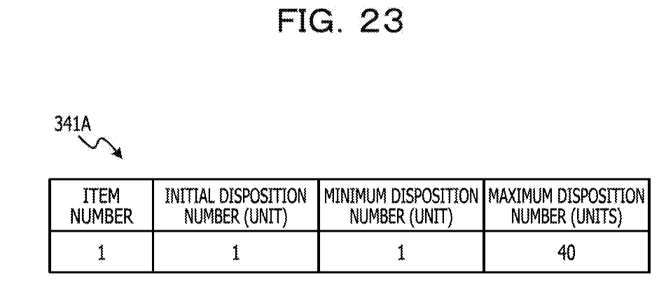

FIG. 23 is a diagram illustrating a specific example of the disposition number management information 341A. The disposition number management information 341A illustrated in FIG. 23 has, as items, “item number” for identifying each piece of information included in the disposition number management information 341A, “initial disposition number” representing an initial disposition number of virtual machines in the physical machine 2A, “minimum disposition number” representing a minimum disposition number, and “maximum disposition number” representing a maximum disposition number.

Specifically, in the disposition number management information 341A illustrated in FIG. 23, “1 (unit)” is set as “initial disposition number”, “1 (unit)” is set as “minimum disposition number”, and “40 (units) are set as “maximum disposition number” in information of which “item number” is “1”.

That is, in a case in which 40 (units) virtual machines are disposed in the physical machine 2A, the increase and decrease process determination unit 332A may determine that the condition that the virtual machines are generated is not satisfied even in the case in which “alarm upper limit” is set in all of “target resource states” in the state management information 342A.

Referring back to FIG. 14, in a case in which it is determined that each AP-VM 32A satisfies the condition that the virtual machine is generated (YES of S34), the packet input and output unit 331A instructs the VM management apparatus 1 to generate a new AP-VM 32A (S35). Thereafter, the VM management apparatus 1 executes processes associated with the generation of the new AP-VM 32A (for example, generation of the new AP-VM 32A, activation of the new AP-VM 32A, installation of an application in the new AP-VM 32A, and setting of the LB-VM 31A). Conversely, in a case in which it is determined that each AP-VM 32A does not satisfy the condition that the virtual machine is generated (NO of S34), the process of S35 is not executed.

In a case in which it is determined that each AP-VM 32A does not satisfy the condition that the virtual machine is generated in the process of S34 (NO of S34) or after the process of S35, the packet input and output unit 311A waits until a subsequent alarm report is received from each AP-VM 32A (NO of S31). Similarly, in a case in which the received alarm report is the normal alarm report in the process of S33 (normal report of S33), the packet input and output unit 311A waits until a subsequent alarm report is received from each AP-VM 32A (NO of S31).

Conversely, in a case in which the received alarm report is the alarm lower limit report in the process of S33 (the lower limit report of S33), the increase and decrease process determination unit 332A determines whether each AP-VM 32A satisfies a condition that the virtual machine is deleted (S36). Specifically, in a case in which “alarm lower limit” is set in all of “target resource states” is set with reference to the state management information 342A, the increase and decrease process determination unit 332A determines that each AP-VM 32A satisfies the condition that the virtual machine is generated.

In the process of S36, the increase and decrease process determination unit 332A may refer to the disposition number management information 341A indicating the number of virtual machines which can be disposed in the physical machine 2A. In a case in which the virtual machines disposed in the physical machine 2A are deleted but the disposition number is not equal to or less than the minimum disposition number of the virtual machines which can be disposed in the physical machine 2A, it may be determined that each AP-VM 32A satisfies the condition that the virtual machine is deleted.

That is, in a case in which only one virtual machine is disposed in the physical machine 2A, the increase and decrease process determination unit 332A may determine that the condition that the virtual machine is deleted is not satisfied even in the case in which “alarm lower limit: is set in all of “target resource states” in the state management information 342A.

In a case in which it is determined that each AP-VM 32A does not satisfy the condition that the virtual machine is deleted in the process of S36 (NO of S36), the packet input and output unit 311A waits until a subsequent alarm report is received from each AP-VM 32A (NO of S31).

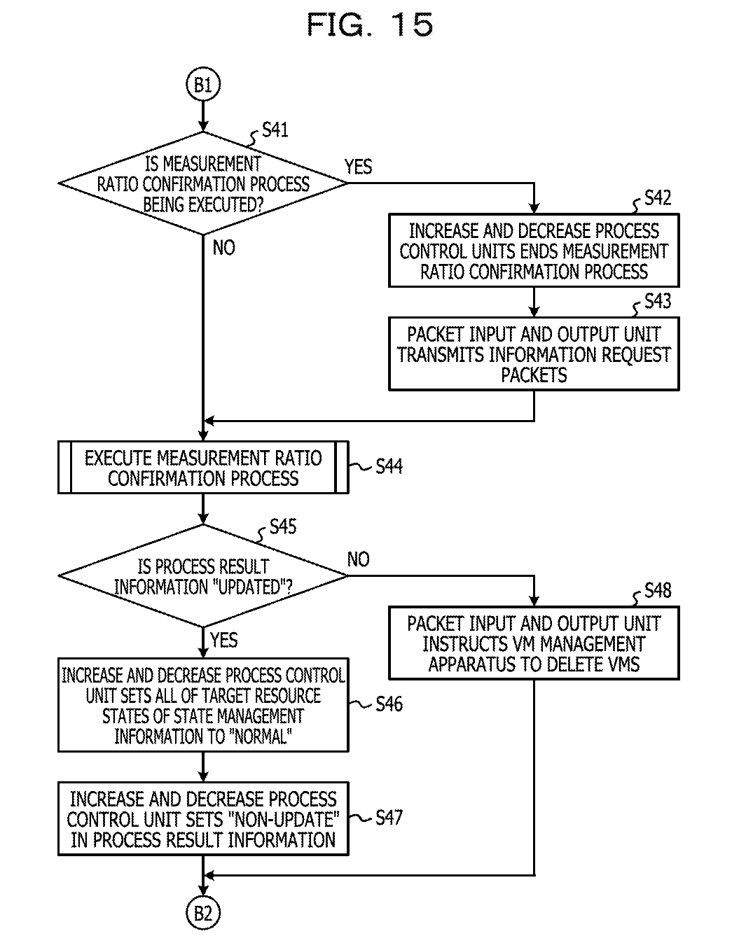

Conversely, in a case in which it is determined that each AP-VM 32A satisfies the condition that the virtual machine is deleted (YES of S36), the increase and decrease process control unit 335A determines whether the measurement ratio confirmation process is executed, as illustrated in FIG. 15 (S41). The measurement ratio confirmation process is a process of updating the first threshold TS1 and the second threshold TS2 according to the operation state of the VP-VM 32A. The details of the measurement ratio confirmation process will be described below.

In a case in which it is consequently determined that the measurement ratio confirmation process is being executed (YES of S41), the increase and decrease process control unit 335A ends the measurement ratio confirmation process which is being executed (S42). Then, the packet input and output unit 331A transmits the information request packets to the LB-VM 31A (S43). Specifically, the information request packet generation unit 334A generates the information request packets in the process of S43. Then, the packet input and output unit 331A transmits the information request packets generated by the information request packet generation unit 334A.

That is, as will be described below, the measurement ratio confirmation process based on the current operation state of the AP-VM 32A is newly executed. Therefore, the increase and decrease process control unit 335A ends the measurement ratio confirmation process which is being executed in the process of S42.

In the process of S43, the increase and decrease process control unit 335A sets “0” as the number of packets of the current count information 321A by transmitting the information request packets to the LB-VM 31A (S22). Accordingly, the increase and decrease process control unit 335A can cause the count unit 314A to count the number of test packets received by the packet input and output unit 311A among the test packets transmitted in the newly executed measurement ratio confirmation process.

The information request packet generation unit 334A generates the information request packets so that the LB-VM 31A can identify the information request packets from the other packets. Specifically, for example, the information request packet generation unit 334A generates the information request packets so that identification information indicating that the packets are the information request packets is included.

In a case in which the measurement ratio confirmation process is not executed (NO of S41), the increase and decrease process control unit 335A starts executing the measurement ratio confirmation process after the process of S42 is executed (S44). Hereinafter, the details of the measurement ratio confirmation process will be described. The measurement ratio confirmation process may be executed at a regular time interval (for example, intervals of 5 minutes) even in a case other than the case in which the increase and decrease process determination unit 332A determines that the condition that the virtual machine is deleted is satisfied.

[Details of Measurement Ratio Confirmation Process]

The packet input and output unit 331A transmits the measurement packets generated by the test packet generation unit 333A to the load balancer 5 in the process of S51 (S51). Specifically, the test packet generation unit 333A generates the test packets in the process of S51. Then, the packet input and output unit 331A transmits the test packets generated by the test packet generation unit 333A.

The test packet generation unit 333A generates the test packets so that the LB-VM 31A can identify the test packets from the other packets. Specifically, the test packet generation unit 333A generates the test packets so that identification information indicating that the packets are the test packets is included.

For example, the test packet generation unit 333A generates the test packets with reference to the test packet management information 345A which is information regarding the number of generated measurement packets or a transmission timing. Hereinafter, a specific example of the test packet management information 345A will be described.

[Specific Example of Test Packet Management Information]

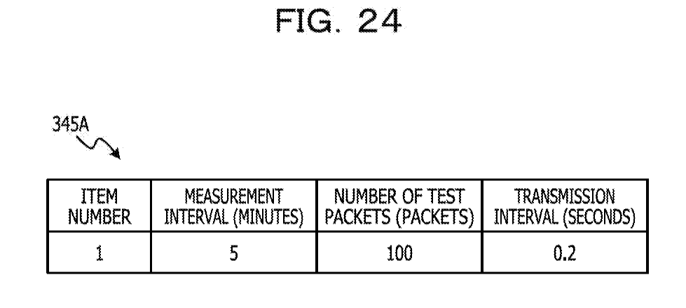

FIG. 24 is a diagram illustrating a specific example of test packet management information 345A. The test packet management information 345A illustrated in FIG. 24 has, as items, “item number” for identifying each piece of information included in the test packet management information 345A and “measurement interval” for setting an interval at which the measurement ratio confirmation process is executed in a case other than the case in which the increase and decrease process determination unit 332A determines that the condition that the virtual machine is deleted is satisfied. The test packet management information 345A illustrated in FIG. 24 has, items, “number of test packets” representing the number of test packets generated whenever the measurement ratio confirmation process is executed and “transmission interval” representing a time interval at which the ASM-VM 33A transmits each test packet to the load balancer 5.

Specifically, in the test packet management information 345A illustrated in FIG. 24, “5 (minutes)” is set as “measurement interval”, “100 (packets)” is set as the number of test packets, and “0.2 (seconds)” is set as “transmission interval” in information of which “item number” is “1”.

Therefore, the test packet generation unit 333A generates 100 (units) test packets with reference to “100 (packets)” set in “number of test packets” of the information of which “item number” is “1” in the test packet management information 345A illustrated in FIG. 24 in, for example, the process of S51.

In the test packet management information 345A illustrated in FIG. 24, “0.2 (seconds)” is set in “transmission interval” of the information of which “item number” is “1” is set. Therefore, in this case, the packet input and output unit 331A transmits the 100 (packets) test packets generated by the test packet generation unit 333A in the process of S51 at the intervals of 0.2 (seconds).

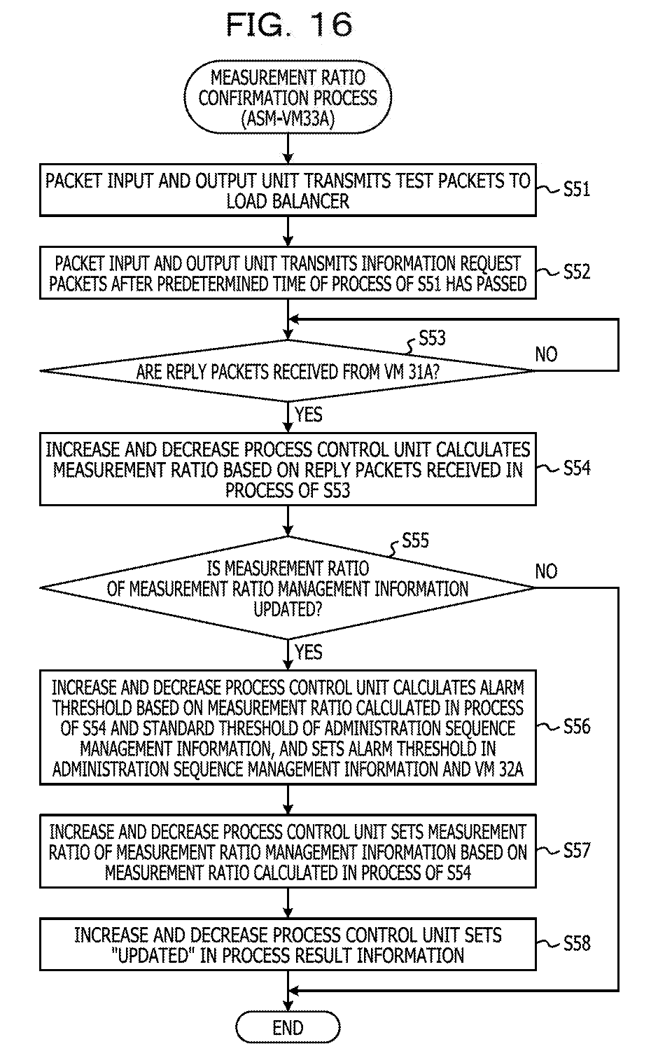

Referring back to FIG. 16, the packet input and output unit 331A transmits the information request packets generated by the test packet generation unit 333A in the process of S51 to the ASM-VM 33A after a predetermined time of the process of S51 has passed (S52). Specifically, the packet input and output unit 331A transmits the information request packets, for example, after 10 (seconds) has passed from the transmission of the test packets in the process of S51.

Thereafter, the increase and decrease process control unit 335A waits until the reply packets are received from the LB-VM 31A (NO of S53). In a case in which the reply packets are received from the LB-VM 31A (YES of S53), the increase and decrease process control unit 335A calculates a measurement ratio based on content of the reply packets received in the process of S53 (S54). The measurement ratio is a ratio of the number of test packets received from the load balancer 5 by the LB-VM 31A to the number of test packets transmitted to the load balancer 5 by the ASM-VM 33A.

Specifically, “55 (packets)” is set in “number of packets” of the information (which is information in which the time set in “time” is the latest time) of which “item number” is “8” in the count management information 322A illustrated in FIG. 20. Therefore, in this case, the information writing unit 315A of the LB-VM 31A generates the reply packets including information indicating that the number of test packets received from the load balancer 5 by the LB-VM 31A is “55 (packets)” (S23).

Accordingly, in this case, the increase and decrease process control unit 335A calculates “55(%)” as the measurement ratio by dividing “55 (packets)” which is the number of packets included in the reply packets by “100 (packets)” which is the number of test packets transmitted by the LB-VM 31A.

Thereafter, the increase and decrease process control unit 335A determines whether the measurement ratio set in the measurement ratio management information 344A is different from the measurement ratio calculated in the process of S54 (whether the measurement ratio is updated) (S55). Hereinafter, specific examples of the measurement ratio management information 344A will be described.

[Specific Examples of Measurement Ratio Management Information]

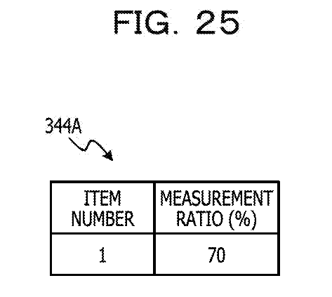

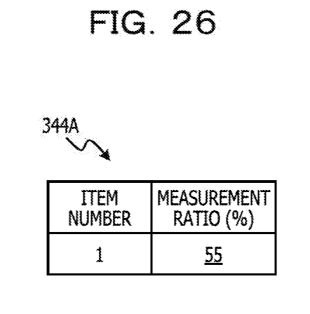

FIGS. 25 and 26 are diagrams illustrating specific examples of measurement ratio management information 344A. The measurement ratio management information 344A illustrated in FIGS. 25 and 26 has, as items, “item number” for identifying each piece of information included in the measurement ratio management information 344A and “measurement ratio” in which the measurement ratio is set. Specifically, in the measurement ratio management information 344A illustrated in FIG. 25, “70(%)” is set in “measurement ratio” of the information of which “item number” is “1”.

Therefore, in the example illustrated in FIG. 25, the increase and decrease process control unit 335A determines that the value (70(%)) set in: “measurement ratio” of the information of which “item number” is “1” in the measurement ratio management information 344A is different from the measurement ratio (55(%)) calculated in the process of S54 (S55). The measurement ratio management information 344A illustrated in FIG. 26 will be described below.

Referring back to FIG. 16, in a case in which the increase and decrease process control unit 335A determines that the measurement ratio of the measurement ratio management information 344A is different from the measurement ratio calculated in the process of S54 (YES of S55), the increase and decrease process control unit 335A calculates the first threshold information TS1 or the second threshold information TS2 (which are also collectively referred to as alarm thresholds below) based on the measurement ratio calculated in the process of S54 and a standard threshold of the administration sequence management information 343A (S56). Then, the increase and decrease process control unit 335A sets the calculated alarm threshold in the administration sequence management information 343A (S56). The administration sequence management information 343A is information which is referred to in order to determine whether to execute generation of a new virtual machine or deletion of the existing virtual machine.

The increase and decrease process control unit 335A may set the calculated alarm threshold in the AP-VM 32A in the process of S56. Specifically, in this case, for example, the increase and decrease process control unit 335A may instruct the packet input and output unit 311A to transmit information indicating the calculated alarm threshold value. Hereinafter, specific examples of the administration sequence management information 343A will be described.

[Specific Examples of Administration Sequence Management Information]

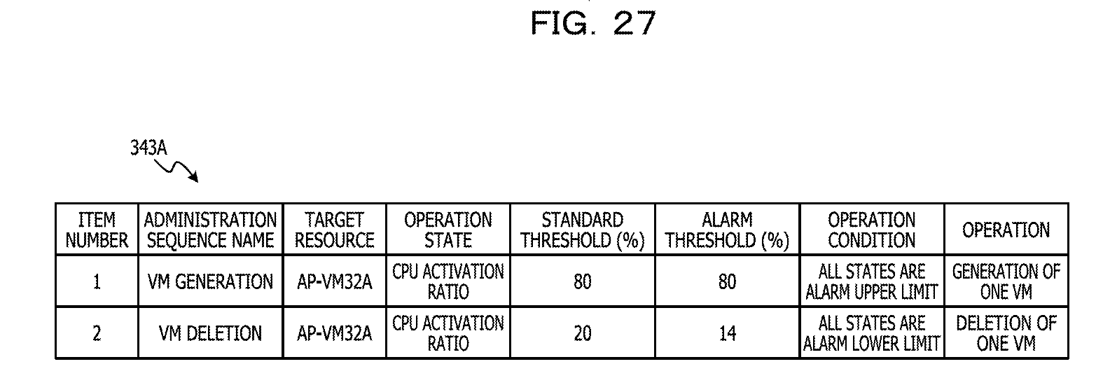

FIGS. 27 to 29 are diagrams illustrating specific examples of administration sequence management information 343A. The administration sequence management information 343A illustrated in FIGS. 27 to 29 has, items, “item number” for identifying each piece of information included in the administration sequence management information 343A, “administration sequence name” representing a kind of administration sequence, and “target resource” representing the virtual machine to which the administration sequence is applied. In “administration sequence”, “VM generation” representing an administration sequence at the time of generation of a virtual machine or “VM deletion” representing an administration sequence at the time of deletion of a virtual machine are set.

The administration sequence management information 343A illustrated in FIGS. 27 to 29 has, as an item, “operation state” representing an operation state of a virtual machine used to determine whether each AP-VM 32A transmits the alarm report to the ASM-VM 33A. The administration sequence management information 343A illustrated in FIGS. 27 to 29 has, as an item, “standard threshold” which is a threshold value for determining whether each AP-VM 32A transmits the alarm report to the ASM-VM 33A in a case in which the switchover of the processes executed in the AP-VMs 32A is not executed.

The administration sequence management information 343A illustrated in FIGS. 27 to 29 has, as an item, “alarm threshold” which is a threshold referred to actually in order to determine whether each AP-VM 32A transmits the alarm report to the ASM-VM 33A. Further, the administration sequence management information 343A illustrated in FIGS. 27 to 29 has, as items. “operation condition” representing a condition that a new virtual machine is generated or the existing virtual machine is deleted and “operation” representing an operation executed in a case in which the condition indicated in “operation condition” is satisfied.

Specifically, in the administration sequence management information 343A illustrated in FIG. 27, “VM generation” is set as “administration sequence name”, “AP-VM 32A” is set as “target resource”, and “CPU activation ratio” is set as “operation state” in the information of which “item number” is “1”. In the administration sequence management information 343A illustrated in FIG. 27, “80(%)” is set as “standard threshold” and “80(%)” is set as “alarm threshold” in the information of which “item number” is “1”. In the administration sequence management information 343A illustrated in FIG. 27, “all states are alarm upper limit” is set as “operation condition” and “generation of one VM” is set as “operation” in the information of which “item number” is “1.”.

Further, in the administration sequence management information 343A illustrated in FIG. 27, “VM deletion” is set as “administration sequence name”, “AP-VM 32A” is set as “target resource”, and “CPU activation ratio” is set as “operation state” in the information of which “item number” is “2”. In the administration sequence management information 343A illustrated in FIG. 27, “20(%)” is set as “standard threshold” and “14(%)” is set as “alarm threshold” in the information of which “item number” is “2”. In the administration sequence management information 343A illustrated in FIG. 27, “all states are alarm lower limit” is set as “operation condition” and “deletion of one VM” is set as “operation” in the information of which “item number” is “2”.

That is, in the administration sequence management information 343A illustrated in FIG. 27, information indicating that one new virtual machine is generated is set in a case in which the CPU activation ratio of all the virtual machines included in the AP-VMs 32A is equal to or greater than “80(%)” which is a value set in “alarm threshold” of the information of which “item number” is “1”. In the administration sequence management information 343A illustrated in FIG. 27, information indicating that one existing virtual machine is deleted is set in a case in which the CPU activation ratio of all the virtual machines included in the VP-VMs 32A is equal to or less than “14(%)” which is a value set in “alarm threshold” of the information of which “item number” is “2”.

In the administration sequence management information 343A, information set in “alarm threshold” of the information of which “administration sequence” is “VM deletion” corresponds to the first threshold information TS1 and information set in “alarm threshold” of the information of which “administration sequence” is “VM generation” corresponds to the second threshold information TS2. Hereinafter, in the administration sequence management information 343A, information set in “standard threshold” of the information of which “administration sequence” is “VM deletion” is referred to as third threshold information TS3 and information set in “standard threshold” of the information of which “administration sequence” is “VM generation” is referred to as fourth threshold information TS4.

In a case in which the measurement ratio of the measurement ratio management information 344A is different from the measurement ratio calculated in the process of S54, the measurement ratio management information 344A is used, for example, to calculate the first threshold information TS1 in the process of S56.

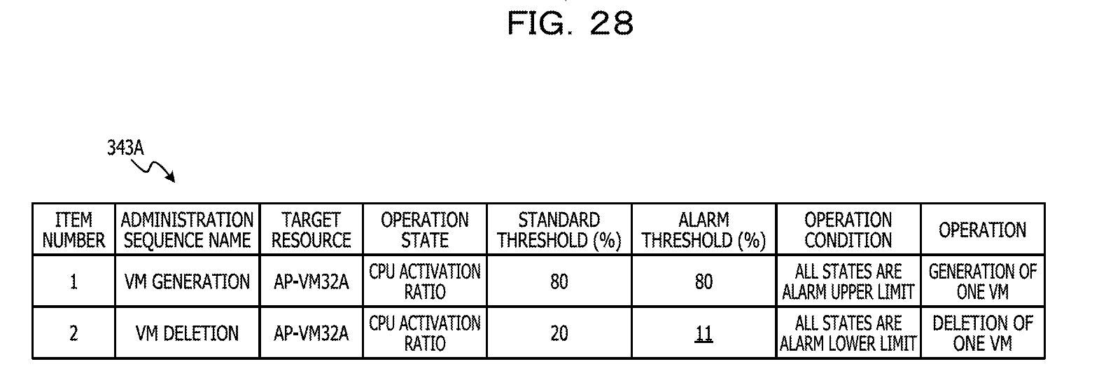

Specifically, for example, the increase and decrease process control unit 335A calculates “11(%)” which is a value obtained by multiplying “20(%)” which is the third threshold information TS3 in the administration sequence management information 343A illustrated in FIG. 27 by “55(%)” which is the measurement ratio calculated in the process of S54. Then, the increase and decrease process control unit 335A sets “11(%)” in the first threshold information in the administration sequence management information 343A illustrated in FIG. 27, as indicated by an underlined portion of FIG. 28.

Accordingly, the increase and decrease process control unit 335A can lower the first threshold information TS1 when the processing load of the AP-VMs 32A is reduced in association with the switchover of some of the processes executed by the AP-VMs 32A to the virtual machines of another group. Therefore, the increase and decrease process control unit 335A can suppress the number of AP-VMs 32A to be deleted even in a case in which the processing load of the VP-VMs 32A is reduced.

Accordingly, even in the case in which a fault of the application after update is found after the switchover of some of the processes from the AP-VMs 32A to the other virtual machines (for example, the AP-VMs 32B), the AP-VMs 32A can execute the processes to be executed. Thus, the service provider can suppress the services provided to the users from being influenced.

Referring back to FIG. 16, the increase and decrease process control unit 335A sets the measurement ratio of the measurement ratio management information 344A based on the measurement ratio calculated in the process of S54 (S57). Specifically, in a case in which the measurement ratio calculated in the process of S54 is “55(%)”, the increase and decrease process control unit 335A sets “55(%)” in “measurement ratio” of the information of which “item number” is “1”, as indicated by the underlined portion of FIG. 26.

Then, the increase and decrease process control unit 335A sets “updated” in process result information (not illustrated) which is information indicating whether the measurement ratio of the measurement ratio management information 344A is updated (S58). The increase and decrease process control unit 335A may also set “non-update (initial value)” in the process result information when the measurement ratio confirmation process is executed (before the process of S31).

In a case in which it is determined that the measurement ratio of the measurement ratio management information 344A is the same as the measurement ratio calculated in the process of S54 (NO of S55), the increase and decrease process control unit 335A does not execute the processes from S56 to S58.

Referring back to FIG. 15, in a case in which the process result information is “updated” (YES of S45), the increase and decrease process control unit 335A updates all of “target resource states” in the state management information 342A to “normal” (S46). That is, the case in which the process result information is “updated” is a case in which the measurement ratio of the measurement ratio management information 344A which is referred to in order decide the information set in “target resource state” in the state management information 342A is updated. Therefore, the increase and decrease process control unit 335A initializes the state management information 342A.

Thereafter, the increase and decrease process control unit 335A sets “non-update” in the process result information and initializes the process result information (S47).

Conversely, in a case in which the process result information is “non-update” (NO of S45), the packet input and output unit 331A instructs the VM management apparatus 1 to delete the existing AP-VMs 32A (S48). Thereafter, the VM management apparatus 1 executes processes associated with the deletion of the existing AP-VMs 32A (for example, processes of deciding the AP-VMs 32A to be deleted, changing the setting of the LB-VM 31A, and deleting the AP-VMs 32A to be deleted). That is, the case in which the process result information is “non-update” is a case in which the measurement ratio of the measurement ratio management information 344A which is referred to in order to decide information set in “target resource state” in the state management information 342A is not updated. Therefore, in this case, the increase and decrease process control unit 335A does not initialize the state management information 342A and deletes the exiting AP-VMs 32A based on the information set in the state management information 342A.

Thereafter, the packet input and output unit 311A waits until a subsequent alarm report is received from each AP-VM 32A (NO of S31).

In this way, the ASM-VM 33A transmits the predetermined number of test packets to the load balancer 5 that distributes the packets to the plurality of groups. Then, the LB-VM 31A acquires the number of test packets received from the load balancer 5 by the first group included in the plurality of groups. Thereafter, based on the number of test packets acquired by the LB-VM 31A, the ASM-VM 33A updates the first threshold information to determine whether to delete the AP-VMs 32A. Further, the ASM-VM 33A deletes the AP-VMs 32A based on the operation states of the AP-VMs 32A and the first threshold information.

Accordingly, the ASM-VM 33A can suppress the AP-VMs 32A from being deleted even in a case in which the processing load of the AP-VMs 32A is reduced in association with the switchover of some of the processes executed by the AP-VMs 32A to other virtual machines (for example, the AP-VMs 32B). Therefore, even in the case in which a fault of the application after update is found after the switchover of some of the processes from the AP-VMs 32A to the other virtual machines, the AP-VMs 32A can execute the processes to be executed. Thus, the service provider can suppress the services provided to the users from being influenced.

[Process in VP-VM 32A]

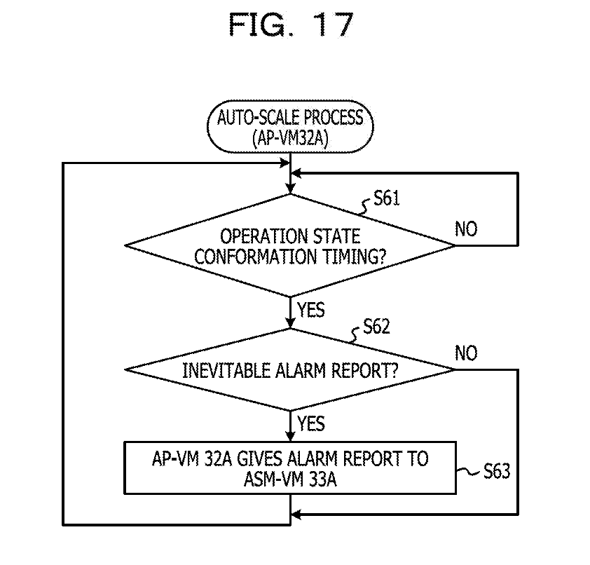

Next, the auto-scale process in the AP-VM 32A will be described. As illustrated in FIG. 17, the AP-VM 32A waits until a timing at which a value (for example, a CPU activation ratio) indicating each operation state is confirmed (hereinafter also referred to as an operation timing confirmation state) comes (NO of S61). The operation state confirmation timing may be, for example, a regular timing such as intervals of 1 minute.

In a case in which the operation state confirmation timing comes (YES of S61), the AP-VM 32A determines whether to inevitably give the alarm report to the ASM-VM 33A (S62). In a case in which the AP-VM 32A consequently determines that the alarm report is inevitably given to the ASM-VM 33A (YES of S62), the AP-VM 32A gives the alarm report to the ASM-VM 33A (S63). Conversely, when the AP-VM 32A determines that the alarm report is inevitably given to the ASM-VM 33A (NO of S62), the AP-VM 32A does not execute the process of S63.

Specifically, for example, the AP-VM 32A periodically acquires the administration sequence management information 343A from the ASM-VM 33A and refers to the first threshold information TS1 and the second threshold information TS2 included in the acquired administration sequence management information 343A at the operation state confirmation timing. In a case in which the value indicating the operation state is equal to or less than the first threshold information TS1 or the value indicating the operation state is equal to or greater than the second threshold information TS2, the AP-VM 32A may give the alarm report to the ASM-VM 33A.

In the process of S56, the AP-VM 32A may store information (information including the first threshold information TS1 and the second threshold value TS2) transmitted from the ASM-VM 33A in an information storage region (not illustrated). In the process of S62, the AP-VM 32A may determine whether to inevitably give the alarm report to the ASM-VM 33A with reference to the information stored in the information storage region.

[Modification Example of First Embodiment]

Next, a modification example of the first embodiment will be described. The increase and decrease process control unit 335A according to the modification example of the first embodiment also updates the second threshold information TS2 of the administration sequence management information 343A in addition to the first threshold information TS1 of the administration sequence management information 343A in the process of S56.

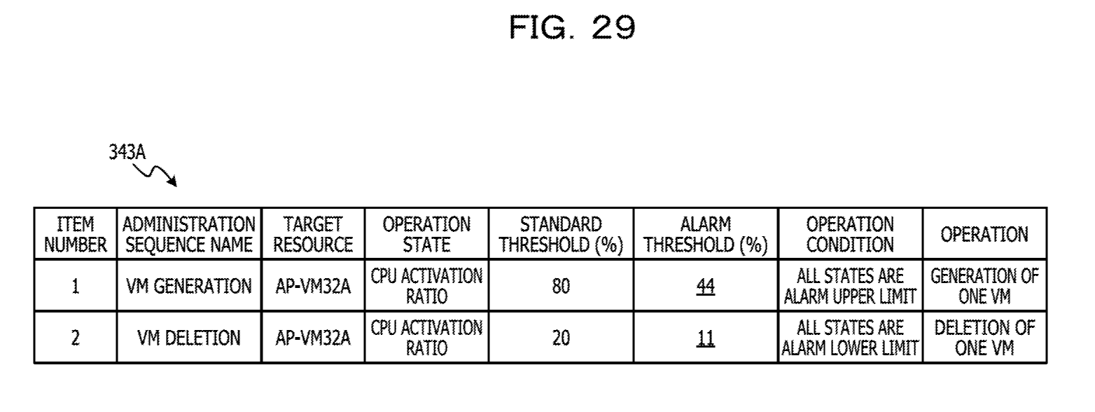

Specifically, the increase and decrease process control unit 335A calculates “44(%)” which is a value obtained by multiplying “80(%)” which is the fourth threshold information TS4 in the administration sequence management information 343A illustrated in FIG. 28 by “55(%)” which the measurement ratio calculated in the process of S54. Then, the increase and decrease process control unit 335A sets “44(%)” in the second threshold information TS2 in the administration sequence management information 343A, as indicated by the underlined portion of FIG. 29.

That is, in this case, in a case in which the switchover of the processes executed by the AP-VMs 32A is executed, more new AP-VMs 32A are generated in the physical machine 2A. Therefore, the AP-VMs 32A can further improve a possibility that the processes to be executed are executed in a case in which abnormality of the application after update is found after the switchover of some of the processes to other virtual machines (for example, the AP-VMs 32B). Therefore, the service provider can suppress an influence on the services to be provided to the users.

### Second Embodiment

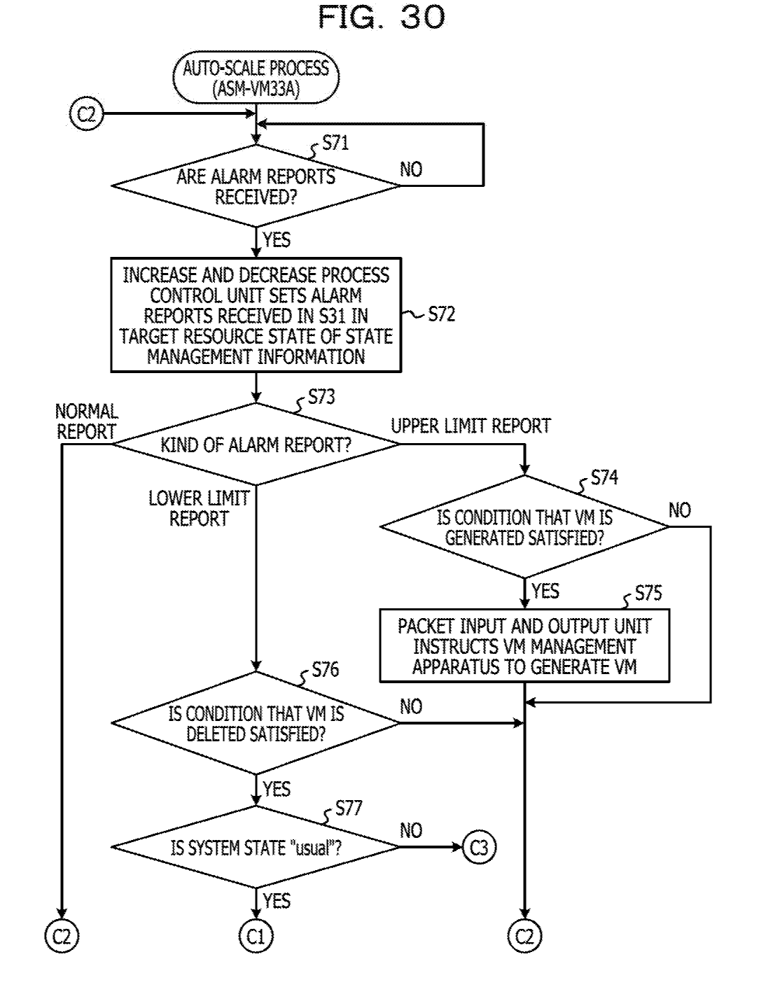

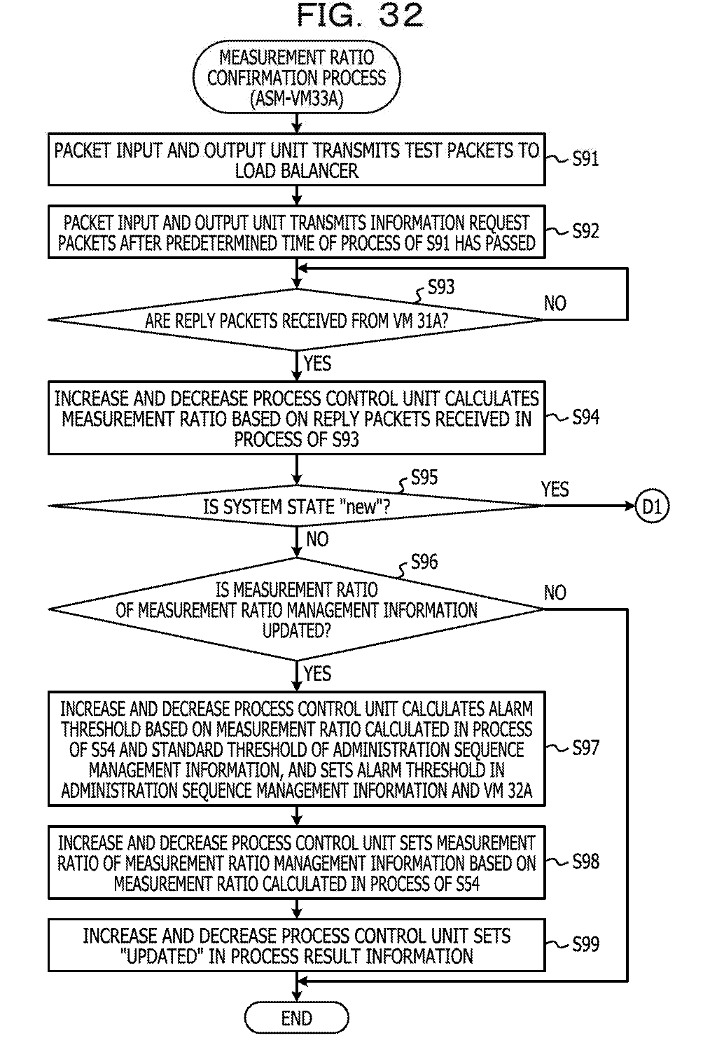

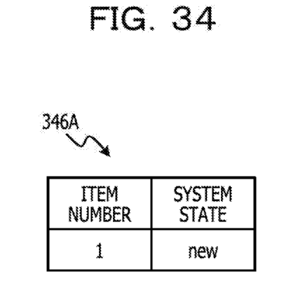

Next, a second embodiment will be described. FIGS. 30 to 33 are flowcharts illustrating an auto-scale process according to the second embodiment. FIG. 34 is a diagram illustrating an auto-scale process according to the second embodiment. The auto-scale process of FIGS. 30 to 33 will be described with reference to FIG. 34.

The physical machine 2A according to the first embodiment does not determine whether processes executed in virtual machines of another group are switched to the AP-VMs 32A. Therefore, even in a case in the processes executed in the virtual machines of the other group can be switched to the AP-VMs 32A, the physical machine 2A executes the auto-scale process described in the first embodiment.

Here, in a case in which the AP-VMs 32A are virtual machines of the process switch destinations, the AP-VMs 32A are not in a situation in which the processes of the virtual machines of the other group have to be executed even in a case in which abnormality is found in an application after update. Therefore, in this case, the AP-VMs 32A may not inevitably execute the auto-scale process described in the first embodiment and suppress the deletion of the virtual machines.

Accordingly, in the physical machine 2A according to the second embodiment, the auto-scale process described in the first embodiment is not executed in a case in which the processes executed in the virtual machines of the other group are switched to the AP-VMs 32A. That is, in the physical machine 2A, the process of calculating the first threshold information TS1 and setting the first threshold information TS1 in the administration sequence management information 343A is not executed. Accordingly, a service provider can suppress the number of virtual machines generated at the time of the switchover of the processes of the AP-VMs 32A. Hereinafter, the details of the second embodiment will be described.

[Details of Second Embodiment]

The packet input and output unit 331A waits until the alarm report is received from the AP-VMs 32A, as in the first embodiment (NO of S71). In a case in which the packet input and output unit 331A receives the alarm report from the AP-VM 32A (YES of S71), the increase and decrease process control unit 335A sets the alarm report received in the process of S71 in the target resource of the state management information 342B (S72).

Thereafter, the increase and decrease process determination unit 332A determines a kind of alarm report received by the packet input and output unit 331A in the process of S71 as in the first embodiment (S73). In a case in which the received alarm report is the alarm upper limit report (the upper limit report of S73), the increase and decrease process determination unit 332A determines whether each AP-VM 32A satisfies the condition that a new virtual machine is generated (S74).

In a case in which it is determined that each AP-VM 32A satisfies the condition that the virtual machine is consequently generated (YES of S74), the packet input and output unit 331A instructs the VM management apparatus 1 to generate a new AP-VM 32A, as in the first embodiment (S75). Thereafter, the VM management apparatus 1 executes processes associated with the generation of the new AP-VM 32A (for example, generation of the new AP-VM 32A, activation of the new AP-VM 32A, installation of an application in the new AP-VM 32A, and setting of the LB-VM 31A). Conversely, in a case in which it is determined that each AP-VM 32A does not satisfy the condition that the virtual machine is generated (NO of S74), the process of S75 is not executed.

In a case in which it is determined that each AP-VM 32A does not satisfy the condition that the virtual machine is generated in the process of S74 (NO of S74) or after the process of S75, the packet input and output unit 311A waits until a subsequent alarm report is received from each AP-VM 32A (NO of S71). Similarly, in a case in which the received alarm report is the normal alarm report in the process of S73 (normal report of S73), the packet input and output unit 311A waits until a subsequent alarm report is received from each AP-VM 32A (NO of S71).

Conversely, in a case in which the received alarm report is the alarm lower limit report in the process of S73 (the lower limit report of S73), the increase and decrease process determination unit 332A determines whether each AP-VM 32A satisfies a condition that the virtual machine is deleted (S76).

In a case in which it is determined that each AP-VM 32A does not satisfy the condition that the virtual machine is deleted in the process of S76 (NO of S76), the packet input and output unit 311A waits until a subsequent alarm report is received from each AP-VM 32A (NO of S71).

Conversely, in a case in which it is determined that each AP-VM 32A satisfies the condition that the virtual machine is deleted (YES of S76), the increase and decrease process control unit 335A determines whether a system state of the system state management information 346A is “usual” (S77). Hereinafter, the system state management information 346A will be described.

[Specific Example of System State Management Information]

FIG. 34 is a diagram illustrating a specific example of the system state management information 346A. The system state management information 346A illustrated in FIG. 34 has, as items, “item number” for identifying each piece of information included in the system state management information 346A and “system state” indicating whether the AP-VM 32A is a virtual machine of a switchover destination. In “system state” “new” representing that the AP-VM 32A is the virtual machine of the switchover destination or “usual” representing that the AP-VM 32A is in a state other than “new” is set. Specifically, in the system state management information 346A illustrated in FIG. 34, “new” is set in “system state” of the information of which “item number” is “1”.

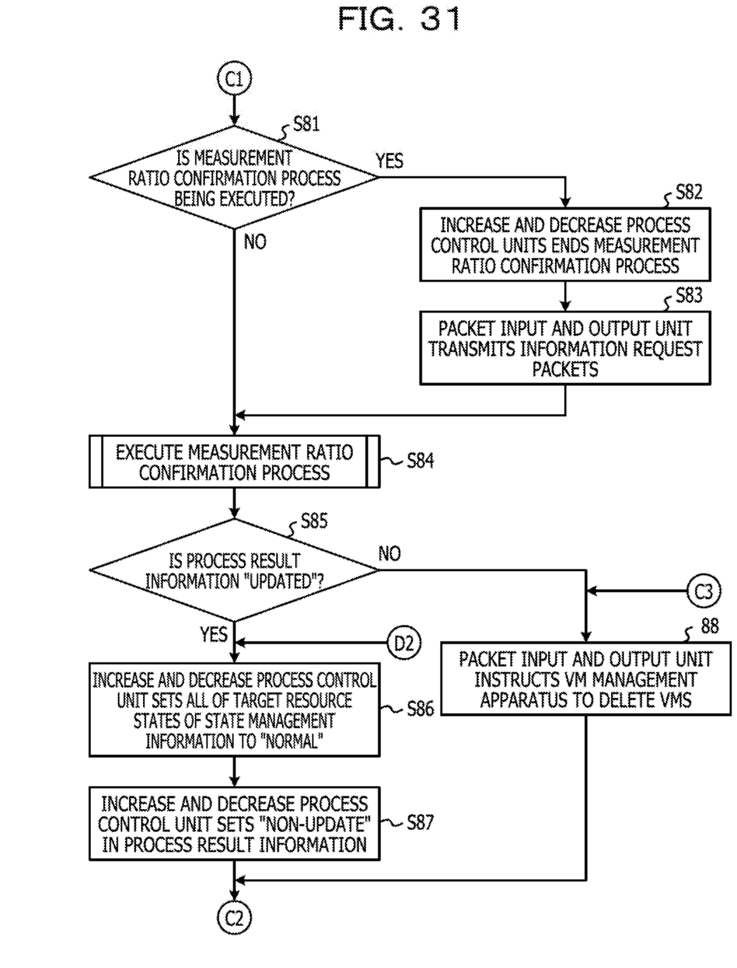

Referring back to FIG. 30, in a case in which the system state of the system state management information 346A is “usual” (YES of S77), the increase and decrease process control unit 335A determines whether the measurement ratio confirmation process is executed as in the first embodiment, as illustrated in FIG. 31 (S81). In a case in which the measurement ratio confirmation process is consequently being executed (YES of S81), the increase and decrease process control unit 335A ends the measurement ratio confirmation process (S82). Then, the packet input and output unit 331A transmits the information request packets to the LB-VM 31A (S83). In a case in which the measurement ratio confirmation process is not being executed (NO of S81) or after the process of S83 is executed, the increase and decrease process control unit 335A executes the measurement ratio confirmation process (S84). Hereinafter, the details of the measurement ratio confirmation process will be described.

[Details of Measurement Ratio Confirmation Process]

The packet input and output unit 331A transmits the measurement packets generated by the test packet generation unit 333A to the load balancer 5, as in the first embodiment (S91). Then, the packet input and output unit 331A transmits the information request packets generated by the information request packet generation unit 334A to the ASM-VM 33A after a predetermined time of the process of S91 has passed (S92).

Thereafter, the increase and decrease process control unit 335A waits until the reply packets are received from the LB-VM 31A, as in the first embodiment (NO of S93). In a case in which the reply packets are received from the LB-VM 31A (YES of S93), the increase and decrease process control unit 335A calculates the measurement ratio based on content of the reply packets received in the process of S93 (S94).

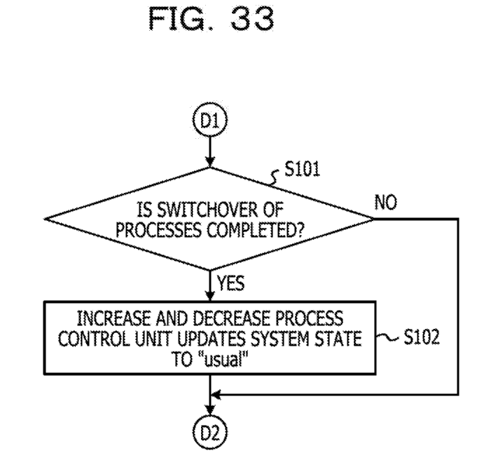

Thereafter, the increase and decrease process control unit 335A determines whether the system state of the system state management information 346A is “new” (S95). In a case in which the system state of the system state management information 346A is “new (YES of S95), the increase and decrease process control unit 335A determines whether the switchover of the processes in the AP-VMs 32A is completed, as illustrated in FIG. 33 (S101). In a case in which the switchover of the processes in the AP-VMs 32A is consequently completed (YES of S101), the increase and decrease process control unit 335A sets “usual” in the system state of the system state management information 346A (S102). Conversely, in a case in which the switchover of the processes in the AP-VMs 32A is not completed (NO of S101), the process of S102 is not executed.

Accordingly, in the case in which the increase and decrease process control unit 335A completes the switchover of the processes in the AP-VMs 32A, the increase and decrease process control unit 335A can execute setting such that the auto-scale process is executed in the first group.

Conversely, in a case in which the system state of the system state management information 346A is “usual” (NO of S95), the increase and decrease process control unit 335A determines whether the measurement ratio management information 344A which is information in which the measurement ratio is set is different from the measurement ratio calculated in the process of S94, as in the first embodiment (S96).

In a case in which the increase and decrease process control unit 335A determines that the measurement ratio of the measurement ratio management information 344A is different from the measurement ratio calculated in the process of S94 (YES of S96), the increase and decrease process control unit 335A calculates the alarm thresholds based on the measurement ratio calculated in the process of S94 and the standard threshold of the administration sequence management information 343A (S97). Then, the increase and decrease process control unit 335A sets the calculated alarm threshold in the administration sequence management information 343A (S97).

In the process of S97, the increase and decrease process control unit 335A may set the calculated alarm threshold in the AP-VM 32A. Specifically, in this case, the increase and decrease process control unit 335A may instruct the packet input and output unit 311A to transmit information indicating the calculated alarm threshold value.

Further, the increase and decrease process control unit 335A sets the measurement ratio of the measurement ratio management information 344A based on the measurement ratio calculated in the process of S94 (S98).

Thereafter, the increase and decrease process control unit 335A sets “updated” in process result information (not illustrated) which is a flag indicating whether the measurement ratio of the measurement ratio management information 344A is updated (S99). In a case in which it is determined that the measurement ratio of the measurement ratio management information 344A is the same as the measurement ratio calculated in the process of S94 (NO of S96), the increase and decrease process control unit 335A does not execute the processes from S97 to S99.

Referring back to FIG. 31, in a case in which the process result information is “updated” (YES of S85), the increase and decrease process control unit 335A updates all of “target resource states” in the state management information 342A to “normal”, as in the first embodiment (S86). Even after the process of S102 or in a case in which the switchover of the processes to the AP-VMs 32A is not completed (NO of S101), the increase and decrease process control unit 335A executes the process of S86.

Thereafter, the increase and decrease process control unit 335A sets “non-update” in the process result information and initializes the process result information, as in the first embodiment (S87).

That is, the increase and decrease process control unit 335A does not execute the processes of S81 to S85 in a case in which the AP-VMs 32A are the process switch destinations. Accordingly, the increase and decrease process control unit 335A can suppress the number of VMs generated in the AP-VMs 32A in the case in which the AP-VMs 32A are the process switch destinations.

Conversely, in a case in which the process result information is “non-update” (NO of S85), the packet input and output unit 331A instructs the VM management apparatus 1 to delete the existing AP-VMs 32A, as in the first embodiment (S88). Thereafter, the VM management apparatus 1 executes processes associated with the deletion of the existing AP-VMs 32A (for example, processes of deciding the AP-VMs 32A to be deleted, changing the setting of the LB-VM 31A, and deleting the AP-VMs 32A to be deleted).

Even in a case in which the system state of the system state management information 346A is “new” (YES of S77), the increase and decrease process control unit 335A executes the process of S88. Thereafter, the packet input and output unit 311A waits until a subsequent alarm report is received from each AP-VM 32A (NO of S71).

The increase and decrease process control unit 335A may also update the second threshold information TS2 of the administration sequence management information 343A in addition to the first threshold information TS1 of the administration sequence management information 343A in the process of S97 as in the modification example of the first embodiment.

Accordingly, the AP-VMs 32A can further improve a possibility that the processes to be executed are executed in a case in which abnormality of the application after update is found after the switchover of some of the processes to other virtual machines (for example, the AP-VMs 32B). Therefore, the service provider can suppress an influence on the services to be provided to the users.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method using a first information processing apparatus included in a plurality of information processing apparatuses and a load balancing apparatus configured to be coupled to the plurality of information processing apparatuses, the first information processing apparatus being configured to operate as a plurality of virtual machines, the method comprising:
transmitting, by the first information processing apparatus, a plurality of packets to the load balancing apparatus;
receiving, by the load balancing apparatus, the plurality of packets;
distributing, by the load balancing apparatus, the plurality of packets to the plurality of the information processing apparatus;
receiving, by the first information processing apparatus, one or more packets included in the plurality of packets distributed by the load balancing apparatus;
deciding, by the first information processing apparatus, a first threshold related to a load of the plurality of virtual machines based on a ratio of a number of the one or more packets to a number of the plurality of packets; and
deleting, by the first information processing apparatus, one or more virtual machines included in the plurality of virtual machines when the load of the plurality of virtual machines is less than the first threshold.

2. The method according to claim 1, the plurality of information processing apparatuses further including a second information processing apparatus configured to operate as a plurality of virtual machines, the method further comprising:
transmitting, by the load balancing apparatus, to the second information processing apparatus, one or more packets included in the plurality of packets different from the one or more packets transmitted to the first information processing apparatus.

3. The method according to claim 2, wherein
the first threshold is a value obtained by multiplying the ratio by a first standard threshold decided when the number of the plurality of packets transmitted from the first information processing apparatus is the same as the number of the one or more packets received by the first information processing apparatus.

4. The method according to claim 2, further comprising:
deciding, by the first information processing apparatus, a second threshold related to the load of the plurality of virtual machines of first information processing device based on the ratio; and
increasing, by the first information processing apparatus, the number of plurality of virtual machines of the first information processing apparatuses when the load of the plurality of virtual machines of the first information processing apparatus is greater than the second threshold.

5. The method according to claim 4, wherein
the second threshold is a value obtained by multiplying the ratio by a second standard threshold used to determine whether to increase the number of plurality of virtual machines of the first information processing apparatuses.

6. The method according to claim 1, wherein
the load is an operation ratio of a processor of the first information processing apparatus or a use ratio of a memory of the first information processing apparatus.

7. The method according to claim 2, wherein
the plurality of virtual machines of the second information processing apparatus take over and execute processes executed by the plurality of virtual machines of the first information processing apparatus.

8. The method according to claim 7, wherein
the plurality of virtual machines of the first information processing apparatus execute a first application program and the plurality of virtual machines of the second information processing apparatus execute a second application program obtained by updating the first application program,
the load is decreased step by step, by decreasing the ratio step by step, and
a process amount by the plurality of virtual machines of the second information processing apparatus is increased step by step.

9. An information processing apparatus configured to operate as a plurality of virtual machines and be coupled to a load balancing apparatus the load balancing apparatus being configured to distribute a first plurality of packets to a plurality of information processing apparatuses including the information processing apparatus, the information processing apparatus comprising:
a memory; and
a processor coupled to the memory and configured to:
transmit a second plurality of packets to a load balancing apparatus,
receive one or more packets included in the second plurality of packets distributed by the load balancing apparatus,
decide a first threshold related to a load of the plurality of virtual machines based on a ratio of a number of the one or more packets to a number of the second plurality of packets, and
delete one or more virtual machines included in the plurality of virtual machines when the load of the plurality of virtual machines is less than the first threshold.

10. The information processing apparatus according to claim 9, wherein
the plurality of information processing apparatuses further including a another information processing apparatus configured to operate as a plurality of virtual machines, and
the load balancing apparatus is configured to transmit, to the another information processing apparatus, one or more packets included in the second plurality of packets different from the one or more packets transmitted to the information processing apparatus.

11. The information processing apparatus according to claim 10, wherein
the first threshold is a value obtained by multiplying the ratio by a first standard threshold decided when the number of the second plurality of packets transmitted from the information processing apparatus is the same as the number of the one or more packets received by the information processing apparatus.

12. The information processing apparatus according to claim 10, wherein the processor is further configured to:
decide a second threshold related to the load of the plurality of virtual machines of the information processing device based on the ratio, and
increase the number of plurality of virtual machines of the information processing apparatuses when the load of the plurality of virtual machines of the information processing apparatus is greater than the second threshold.

13. The information processing apparatus according to claim 12, wherein
the second threshold is a value obtained by multiplying the ratio by a second standard threshold used to determine whether to increase the number of plurality of virtual machines of the information processing apparatuses.

14. The information processing apparatus according to claim 9, wherein
the load is an operation ratio of the processor or a use ratio of the memory.

15. The information processing apparatus according to claim 10, wherein
the plurality of virtual machines of the another information processing apparatus take over and execute processes executed by the plurality of virtual machines of the information processing apparatus.

16. The information processing apparatus according to claim 15, wherein
the plurality of virtual machines of the information processing apparatus execute a first application program and the plurality of virtual machines of the another information processing apparatus execute a second application program obtained by updating the first application program,
the load is decreased step by step, by decreasing the ratio step by step, and
a process amount by the plurality of virtual machines of the another information processing apparatus is increased step by step.

17. A non-transitory computer-readable storage medium storing a program that causes an information processing apparatus to execute a process, the information processing apparatus being configured to operate as a plurality of virtual machines and be coupled to a load balancing apparatus, the load balancing apparatus being configured to distribute a first plurality of packets to a plurality of information processing apparatuses including the information processing apparatus, the process comprising:
transmitting a second plurality of packets to a load balancing apparatus;
receiving one or more packets included in the second plurality of packets distributed by the load balancing apparatus;
deciding a first threshold related to a load of the plurality of virtual machines based on a ratio of a number of the one or more packets to a number of the second plurality of packets; and
deleting one or more virtual machines included in the plurality of virtual machines when the load of the plurality of virtual machines is less than the first threshold.

18. The non-transitory computer-readable storage medium according to claim 17, wherein
the plurality of information processing apparatuses further including a another information processing apparatus configured to operate as a plurality of virtual machines, and
the load balancing apparatus is configured to transmit, to the another information processing apparatus, one or more packets included in the second plurality of packets different from the one or more packets transmitted to the information processing apparatus.

19. The non-transitory computer-readable storage medium according to claim 18, wherein
the first threshold is a value obtained by multiplying the ratio by a first standard threshold decided when the number of the second plurality of packets transmitted from the information processing apparatus is the same as the number of the one or more packets received by the information processing apparatus.

20. The non-transitory computer-readable storage medium according to claim 18, the process further comprising:
deciding a second threshold related to the load of the plurality of virtual machines of the information processing device based on the ratio; and
increasing the number of plurality of virtual machines of the information processing apparatuses when the load of the plurality of virtual machines of the information processing apparatus is greater than the second threshold.
